(19) United States
(12) Patent Application Publication
(10) Pub. No.: US 2013/0340057 A1
(43) Pub. Date: Dec. 19, 2013

(54) Image Facilitated Password Generation User Authentication And Password Recovery

(71) Applicant: Vladimir V. Kitlyar, Sankt-Petersburg (RU)

(72) Inventor: Vladimir V. Kitlyar, Sankt-Petersburg (RU)

(73) Assignee: RAWLLIN INTERNATIONAL INC., Tortola, VI (US)

(21) Appl. No.: 13/495,320

(22) Filed: Jun. 13, 2012

(51) Int. Cl. G06F 21/00; G06F 7/04

(52) U.S. Cl. 726/6; 726/7

(57) ABSTRACT

User authentication systems and supporting methods and devices are described. For instance, the disclosed subject matter describes image-facilitated generation of user authentication credentials, user authentication, etc. for a user and related functionality, where a selection of images can correspond to a grammatical structure comprising disparate parts of speech according to various non-limiting aspects. The disclosed details enable various refinements and modifications according to system design and tradeoff considerations.

### FIELD OF THE INVENTION

The disclosed subject matter relates generally to passwords and user authentication and, more particularly, to systems for generation of user authentication credentials, user authentication, and user authentication credential recovery facilitated by images, and supporting methods and devices.

### BACKGROUND OF THE INVENTION

Passwords, commonly implemented as a secret word or phrase, authenticate a user prior to being granted access to a place, organization, computer system, etc. Regarding computer system access, passwords traditionally comprise a sequence of characters that are required to be entered into a computer to gain access to a part of the computer system, and passwords traditionally comprise a combination of numerical, alphabetic, or symbolic characters.

However, computer systems can have different policies and technical requirements regarding password generation, use, and/or forgotten or lost password recovery. This, in turn, can result in users having to remember passwords, secret answers to questions, and so on from the multitude of systems with which they are associated. As a consequence, passwords are frequently chosen by users primarily on the basis that the password is easily remembered by the user. This can result in low security passwords being employed with attendant security risks. As an example, users can be tempted to use a previously memorized password character sequence, such as a significant date, a personal identification number, a telephone number, and so on.

As a result of a history of compromised passwords and user accounts, computer systems have used increasingly sophisticated password generation and recovery techniques, which have forced complicated and onerous password policies upon users. As an example, users may be obliged to change their passwords frequently, users may be forced to choose passwords having special characters or passwords of a certain length and character combinations that have no special personal significance to users, and/or users may be administratively prohibited from copying such passwords down to avoid security breaches due to an errant or misplaced password. Consequently, users are ideally expected to memorize each individual password for the multitude of computer systems that they access, without any consideration of the frequency that these passwords must be changed, without consideration for the ability to memorize such a large number of complex character combinations, and without any meaningful way to commit such complex character combinations to memory. Despite any restrictions to the contrary, users may opt to save their passwords in an insecure location, such as an easily accessed notepad or an unencrypted computer file, to avoid being inconvenienced by a computer system's rejection of erroneous password entries.

Thus, computer users and computer systems remain vulnerable to determined computer criminals using well-proven techniques, which can exploit the constantly conflicting goals of improving computer and user account security and computer system usability as evidenced by the inability to account for and remember passwords from a multitude of systems. Moreover, to allow users that forget their passwords to gain access to computer systems, increasing amounts of personal data are requested to facilitate user verification prior to sending or resetting a lost or forgotten password. Ultimately, a telephone call to a help desk can be the only step that can restore access to automated computer systems; a process that is cumbersome, costly, and partially negates the benefits of automated computer systems in the first instance.

In addition, although attempts have been made to implement user authentication using one or more image(s) or a combination of images and/or character strings, the problem of users having to remember passwords or their image related equivalents remains a formidable challenge. As such, a user authentication strategy that triggers a user's memory beyond simple visual memory triggering facilitated by image representations would provide users an enhanced ability to remember passwords or user authentication credentials and thereby limit cumbersome and costly tech support intervention for lost of forgotten passwords.

The above-described deficiencies are merely intended to provide an overview of some of the problems encountered in user authentication credential generation and recovery, user authentication, and supporting methods and devices and are not intended to be exhaustive. Other problems with conventional systems and corresponding benefits of the various non-limiting embodiments described herein may become further apparent upon review of the following description.

### SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the disclosed subject matter in a simplified form as a prelude to the more detailed description that follows.

In consideration of the above-described deficiencies of the state of the art, the disclosed subject matter provides apparatuses, related systems, and methods associated with user authentication credential generation, user authentication, and user authentication credential recovery facilitated by images.

According to various non-limiting aspects, the disclosed subject matter provides device, systems, and methods for generating a user authentication credential and user authentication facilitated by images, where a selection of images can correspond to a grammatical structure comprising disparate parts of speech. In further non-limiting implementations, the disclosed subject matter can facilitate displaying or presenting images based on a random or pseudo-random determination of images to be presented or displayed and/or based on a language processing algorithm, to facilitate generating a user authentication credential and/or user authentication.

Thus, in various non-limiting implementations, the disclosed subject matter provides systems, devices, and methods that facilitate generating, storing, transmitting, and/or verifying a user authentication credential to facilitate permitting access to a restricted access system or device, comparing the user authentication credential to a stored user authentication credential, resetting a stored user authentication credential, determining that a user is authorized to access a another user authentication credential, or granting access to restricted access information, and so on, etc.

These and other embodiments are described in more detail below.

### BRIEF DESCRIPTION OF THE DRAWINGS

The disclosed techniques and related systems and methods are further described with reference to the accompanying drawings in which:

FIG. 1 depicts a functional block diagram illustrating an exemplary environment suitable for use with aspects of the disclosed subject matter;

FIG. 2 depicts another functional block diagram illustrating an exemplary environment and demonstrating further non-limiting aspects of the disclosed subject matter;

FIG. 3 illustrates an overview of an exemplary computing environment suitable for incorporation of embodiments of the disclosed subject matter;

FIGS. 4-6 depict flowcharts of exemplary methods according to particular non-limiting aspects of the subject disclosure;

FIG. 7 illustrates exemplary non-limiting systems suitable for performing various techniques of the disclosed subject matter;

FIG. 8 illustrates exemplary non-limiting systems or apparatuses suitable for performing various techniques of the disclosed subject matter;

FIG. 9 illustrates non-limiting systems or apparatuses that can be utilized in connection with systems and supporting methods and devices as described herein;

FIGS. 10-12 demonstrate exemplary block diagrams of various non-limiting embodiments, in accordance with aspects of the disclosed subject matter;

FIG. 13 illustrates a schematic diagram of an exemplary mobile device (e.g., a mobile handset) that can facilitate various non-limiting aspects of the disclosed subject matter in accordance with the embodiments described herein;

FIG. 14 is a block diagram representing an exemplary non-limiting networked environment in which the disclosed subject matter may be implemented;

FIG. 15 is a block diagram representing an exemplary non-limiting computing system or operating environment in which the disclosed subject matter may be implemented; and

FIG. 16 illustrates an overview of a network environment suitable for service by embodiments of the disclosed subject matter.

### DETAILED DESCRIPTION OF ILLUSTRATIVE EMBODIMENTS

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow.

It is understood that various modifications may be made by one skilled in the relevant art without departing from the scope of the disclosed subject matter. Accordingly, it is the intent to include within the scope of the disclosed subject matter those modifications, substitutions, and variations as may come to those skilled in the art based on the teachings herein.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more component(s) may reside within a process and/or thread of execution and a component may be localized on one computer and/or distributed between two or more computers.

Also, the terms “user,” “mobile user,” “device,” “mobile device,” “computer system,” and so on can be used interchangeably to describe technological functionality (e.g., device, components, or sub-components thereof, combinations, and so on etc.) configured to at least receive and transmit electronic signals and information, or a user thereof, according to various aspects of the disclosed subject matter. Furthermore, depending on context, the terms “images,” “graphical images,” or the like can refer to digital information related to a visual representation associated with a person, a place, and/or a thing, to include an action, an emotion, a symbol, a character, a number, a shape, a part of speech, and the like, without limitation, whether photographic and/or synthesized using computer graphics techniques, and/or whether concerning real and/or abstract phenomena. For example, an image can be, but is not limited to being, a visual representation associated with a single identifiable thing (e.g., a person, a place, and/or a thing, etc.) and/or a visual representation associated with a multiple identifiable things (e.g., persons, places, and/or things, etc.), a combination of sub-images composing a scene, each of which can be referred to as an image. Thus, an identifying characteristic of an image, in whatever form, is that the image can be presented or displayed to a user, as described herein, according to techniques for user authentication credential generation and user authentication of the disclosed subject matter.

As further used in this application, the terms “user authentication credential,” “password,” and the like can refer to digital information that can facilitate one or more of determining whether a user or a thing (e.g., a device, a computer, etc.) is, in fact, who or what it is declared to be, determining whether to allow, permit, and/or deny a pending process, action, or result, etc., determining whether to allow access to a restricted access entity (e.g., a restricted access system, computer, device, account, service, information store, component, sub-component, and so on, or other entity that, without the user authentication credential, cannot be accessed, etc.), and so on. For example, as described herein, a user authentication credential can comprise one or more images or sub-images, one or more characters (e.g., letters, numbers, symbols, special characters, textual or non-textual characters, dialect-specific characters or symbols, and so on, etc.), one or more character strings (e.g., a number of characters, etc.), combinations thereof, and so on, without limitation. In addition, as used herein, the term “grammatical structure” can refer to a character string associated with one or more part(s) of speech (e.g., subject, noun, pronoun, verb, adjective, complement, direct object, an indirect object, preposition, an object of the preposition, conjunctions, interjections, and so on, etc.) that can comprise a sentence or phrase and/or portions thereof, as further exemplified below. Moreover, depending on context, as further used herein, the term “grammatical structure” can refer to a character string that can comprise one or more characters that are not associated with the one or more parts of speech, in addition to the one or more parts of speech, in lieu of the one or more parts of speech, or any combination thereof.

As described above, deficiencies in conventional user authentication schemes result from the conflicting goals of providing device, system, account, and personal information security, and usability as a result of the limited capacity of a user to remember the multitude of user authentication credentials for the numerous systems with which the user interacts. In addition, users can be presented with multiple credentials with which to interact with a system, device, or component, for instance, based on the technical level of the operations the user wishes to perform (e.g., simple access such as device unlocking, access advanced or administrative functions, etc.).

As an example regarding wireless devices, Device Lock codes, Subscriber Identity Module (SIM) personal identification numbers (PINs), and PIN Unlock Key (PUK) codes illustrate the requirement of having to remember various user authentication credentials when interacting with the security and functionality of a wireless device. A Device Lock code can be a security code on a device, including wireless devices, that can prevent unauthorized use. In one example, devices can have a preprogrammed code from the manufacturer, whereas in other examples devices can have a user-defined code. Whereas a Device Lock Code can be used to unlock basic user functionality of a wireless device, a SIM PIN can be used to prevent unauthorized use of a SIM card. In addition, a PUK code can be required to unlock SIM cards that have become locked following a number of successive incorrect PIN entries. These examples illustrate that, even with one simple device, users can be required to remember a number of distinct user authentication credentials.

One method of enabling a particular user to remember his or her user authentication credentials (e.g., a password, a passphrase, one or more image(s), one or more character string(s) any combination thereof, etc.) is to attach a personal significance to the user authentication credentials beyond the simple fact that the user authentication credentials enable access to a computer system, device, account, etc. For instance, personal significance can be of a pre-existing nature such as a pet's name, a favorite color, a previously memorized character sequence, such as a significant date, a personal identification number, a telephone number, and so on. However, as these instances are subject to data collection, data mining, and possible compromise, another option that creates a new personal significance (e.g., aside from the mere fact of being authentication credentials) would enhance a user's ability to remember his or her authentication credentials, without relying on information that could have been catalogued and/or is subsequently exploitable. For example, as described above, user authentication using one or more image(s) or a combination of images and character strings can have the ability to trigger a user's visual memory. In addition, a funny or peculiar turn of phrase or sentence can create a lasting memory due to the peculiarity or humor of the phrase or sentence personally attributed to the phrase or sentence by a user.

Accordingly, in various non-limiting implementations, the disclosed subject matter provides devices, systems, and methods for user authentication credential generation, user authentication, and user authentication credential recovery. In a non-limiting aspect, exemplary systems and supporting methods and devices can employ a plurality of images determined based in part on artificial intelligence such as language processing and generation to facilitate password generation and recovery and user authentication.

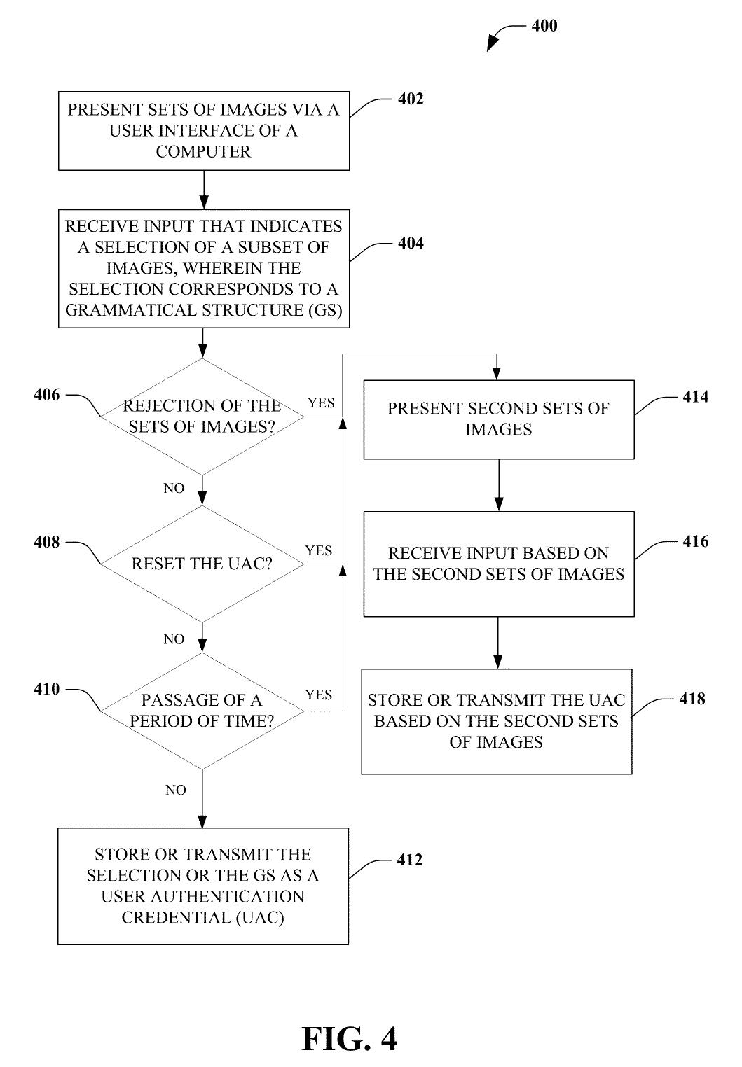

As a non-limiting example, an exemplary interface implementation can comprise a presentation of a multiple digit (e.g., such as three or more digits) “drum” with one or more image(s) (e.g., with one or more symbol(s), picture(s), etc.) per digit presented to a user, where each digit can have a number of rotating image cells associated with a digit, for instance, as further described herein, regarding FIGS. 4-12. Thus, as described herein, the “drum” can comprise a series or a number of sets of images, where each digit can correspond to a set of images, and where each image of the set of images, can correspond to an image cell of the digit. Without limitation, for discussion purposes, the rotating or scrollable image cells of the digits of the drum can be equated to the familiar slot machine, where the image cells of the digits can be equated to the rotors of the slot machine, and where the image cells depicting images can be equated to the individual pictures on the reels. In a further non-limiting aspect, each of the multiple rotating image cells of the digits can have a number of images of the one or more image(s) presented to the user. Furthering the slot machine analogy, the images of the image cells can be equated to possible outcomes for a column of the slot machine rotors. In another non-limiting example, verbal “labels” that can be associated with the graphical images of the image cells can also be presented to the user.

In further non-limiting implementations, each digit can represent one of a number of disparate parts of speech responsible for a certain part of a sentence. For instance, a minimal exemplary sentence can comprise a subject (e.g., a noun, a pronoun, etc.) and a verb, non-limiting embodiments of such minimal sentences can include combinations of subject and verb as Follows: “Boy runs.; Sun rises.; Airplanes fly.;” and so on. More complex sentences can be of the form subject, verb, and adverb, non-limiting examples of such sentences can include as follows: “Boy runs slow.; Sun rises early.; Airplanes fly low.;” and so on. In addition, more complex sentences can include other parts of speech beyond subject, verb, and adverb, such as, without limitation, adjectives, prepositions, direct objects, and so on, for example. In themselves, these sentences are not particularly memorable and/or are not likely to generate personal significance for a user such that, as part of a user authentication credential, the user authentication credential is not likely to be particularly memorable.

However, according to a non-limiting aspect, upon a user, or a device on behalf of the user, initiating a run of the exemplary interface “drum,” the interface can generate a random (e.g., random or pseudo-random) combination of images, where the image cells associated with the one or more image(s) corresponding to each digit can be randomly or pseudo-randomly determined for each digit. Thus, images presented or displayed, and/or respective labels, can appear in a random or pseudo-random fashion, leading the user to experience humorous or peculiar turns of phrase or sentences that can facilitate generating memorable user authentication credentials.

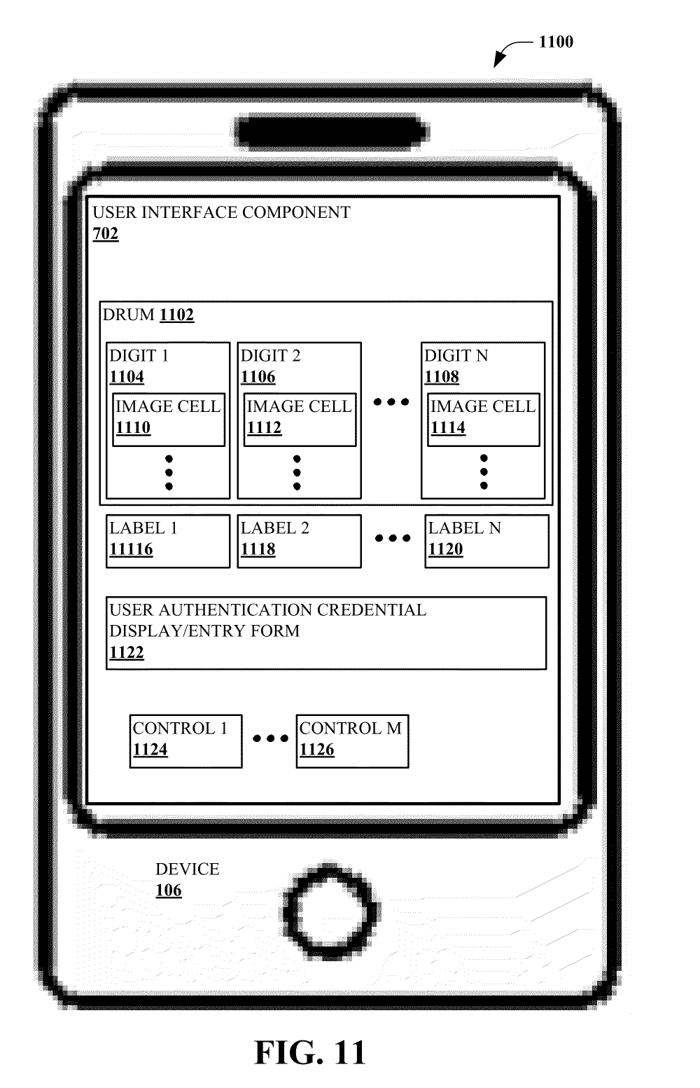

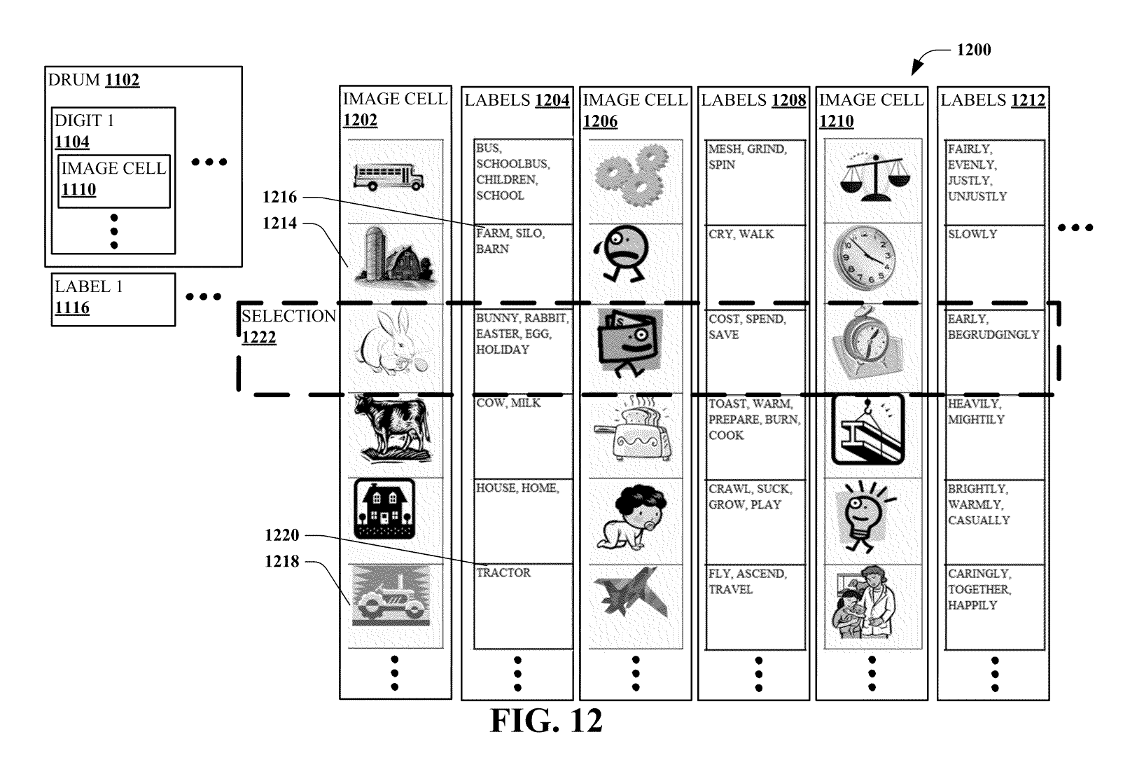

For instance, in an exemplary implementation such as further described below regarding FIGS. 11-12, three digits of a drum can correspond to disparate parts of speech (e.g., subject, verb, and adverb, respectively, etc.), a result of which can be the presentation of three images of the image cells, each of which image can be interpreted by a user, or associated by a device or system with one or more label(s), and which are related to the disparate parts of speech (e.g., subject, verb, and adverb, respectively, etc.). Due in part to the random (e.g., random or pseudo-random) combination of images, due in part to the predetermined selections of one or more image(s) (e.g., with one or more symbol(s), pictures, etc.) per image that is presented to a user, and/or due in part to the unique nature of the significance of the images to the user, the presentation of images of the image cells in the digits of the drum can create a visual pattern that is generated by a system or device and that can be interpreted by the user as the peculiar sentence or turn of phrase, thereby facilitating the generation of memorable user authentication credentials.

For instance, as a result of a proposed artificially generated user authentication credential that does not coincide with the well-established figure of speech, the system can generate a nonsense sentence or turn of phrase (e.g., for a system that presents labels with the images), or the images can be interpreted by the user as a peculiar sentence or turn of phrase. For example, the nonsense verse poem, “Jabberwocky,” written by Lewis Carroll in the1872 novel, “Through the Looking-Glass, and What Alice Found There,” is particularly memorable in its peculiarity. Based on this principle of a peculiarity being innately memorable, which can cause a user authentication credential to be especially memorable (e.g., for a system that presents labels with the images), the user authentication credential can achieve personal significance for the user (e.g., via interpretation of the images into a peculiar sentence or turn of phrase, etc), which can be difficult to guess due to a user's distinct interpretation of the images in the presented image cells.

In another non-limiting aspect, if a user does not like a proposed user authentication credential in the form of the presented images of the image cells, or if it is inconvenient or difficult to the user to remember, systems and devices as described herein can generate a new user authentication credential in the form of newly presented image cells and/or respective labels.

In other non-limiting implementations as described above, each digit of the drum can comprise a number of images in the image cells, and each image of the image cells can comprise a number of images or sub-images to comprise a scene, as further described below regarding FIG. 12, for example. In an exemplary implementation, a drum of an exemplary user interface can comprise three digits, where each digit can correspond to disparate parts of speech (e.g., subject, verb, and adverb, respectively, etc.), and/or where each digit of the drum can comprise or be associated with 10 image cells. The images of the image cells can be presented randomly to stimulate the user to respond with a nonsense sentence or turn of phrase, and/or the images of the image cells can be presented with labels to present to a user a system-determined nonsense sentence or turn of phrase.

As described in more detail below, a number of variations and options are possible within the scope of the disclosed subject matter. As a brief overview, in addition to the above-described variations, the number of instances that a user is permitted to respond with the user's authentication credentials can be varied, and/or the number of “digits,” parts of speech, “image cells,” images per image cell, and so on can also be varied. In addition, the type of user authentication credential can also be varied. As non-limiting examples, the credential can be in the form of a set of selected pictures, a system-generated nonsense sentence (e.g., for a system that presents labels with images), a user-generated nonsense sentence prompted by the exemplary interface presentation of the images of the image cells, combinations thereof, and so on. As a further non-limiting example, upon a user attempting to respond to a challenge soliciting a user authentication credential, the user can respond with the user authentication credential by manually spinning the “digits” of the “drum” (e.g., scrolling through sets of images) and submitting the user input based on the selection, the user can enter the user authentication credential in the form of a character string, or can enter the user input in any combination thereof.

Thus, in a particular non-limiting aspect, the user is not required to remember an exact secret phrase as a user authentication credential. Instead, the user can recall the user authentication credential, drawing on the user's visual memory while scrolling through each image of the image cells (e.g., either with or without labels presented), by manually scrolling the images of the “drum,” in addition to the utilizing an ability to recall the user authentication credential by virtue of the peculiar or nonsensical nature of the sentence or turn of phrase. In this sense, an exemplary interface can prompt the user visually and/or verbally in addition to drawing on the user's ability to memorize peculiar or nonsense sentences or turns of phrase.

In addition, in other non-limiting implementations, an exemplary system or device can periodically prompt a user to determine whether the user can remember the user authentication credential, and if the user has not, the exemplary system can present options to reset an expired user authentication credential and/or can present options recover a lost or forgotten user authentication credential. In still other non-limiting implementations, various embodiments of the disclosed subject matter can be employed to, for example, access other user authentication credentials, similar to the SIM/PIN/PUK examples, as described above.

In still further non-limiting implementations, one or more image(s) that are displayed or presented can be associated with one or more other character strings, which are not indicative of the content of the one or more image(s). As a non-limiting example, consider two images that comprise content that can be associated with respective labels, “silly” and “dog” (e.g., an image of a clown hat associated with “silly,” and an image associated with “dog,” etc.). These two images can also be associated with one or more other character string(s), such as, “H7t” and “k09J72,” respectively (e.g., an image associated with “H7t,” and an image associated with “k09J72”, etc.), such that user input accepted or received can comprise a character string, “H7tk09J72”, as a user authentication credential.

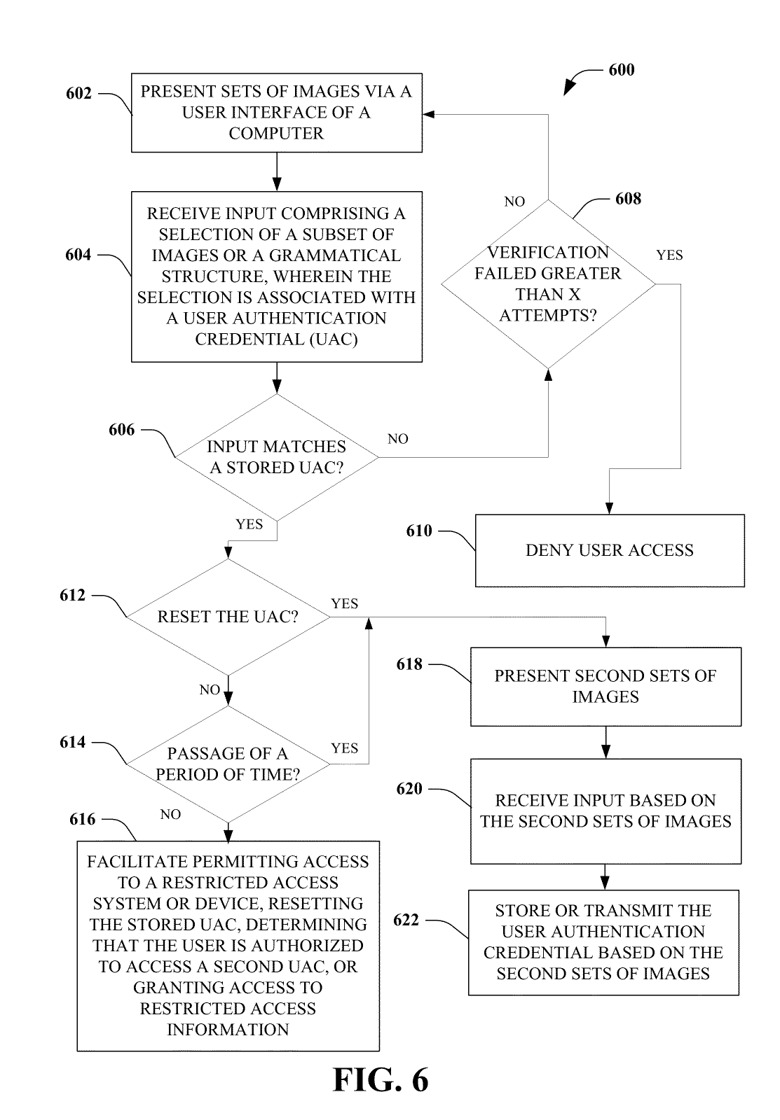

In a further non-limiting aspect, as further described herein, receiving or accepting input comprising a selection of images or a grammatical structure associated with a user authentication credential can include the one or more other character strings, which are not indicative of the content of the one or more image(s), as described above. For instance, receiving or accepting input comprising a selection of images or a grammatical structure associated with a user authentication credential can include the character string, “H7tk09J72”, as a user authentication credential, as described above. Thus, as further described below, for example, regarding FIGS. 6, 12, etc., receiving or accepting input can include receiving or accepting a combination of one or more image(s) of the selection and a subset of the grammatical structure, where the subset of the grammatical structure can include one or more other character string(s) such as the character string, “H7tk09J72”, described above, as a user authentication credential (e.g., for use as a password or passphrase, etc.), and/or where the one or more image(s) of the selection can include the one or more images as a user authentication credential for recovering another user authentication credential as described herein (e.g., the character string, “H7tk09J72” or grammatical structure as a user authentication credential for use as a password or passphrase, etc.), for example, regarding, FIGS. 6, 12, etc.

In still further exemplary implementations, as an alternative to users opting to save traditional passwords in an insecure location, such as an easily accessed notepad or an unencrypted computer file, various embodiments of the disclosed subject matter can facilitate printing one or more image(s) as a reminder of the user authentication credential, as a reminder of a grammatical structure, as a reminder of a character string, and or any combination thereof, according to still further non-limiting aspects. It can be understood that, in various non-limiting implementations, the one or more images can be different from the one or more image(s) employed as a user authentication credential for recovering the other user authentication credential as described above. In yet another non-limiting aspect, printing the one or more image(s) can include printing one or more image(s) that are suggestive of the user authentication credential (e.g., the character string, “H7tk09J72” or grammatical structure as a user authentication credential for use as a password or passphrase, etc.). As a further non-limiting example, in various aspects, a correlation between the one or more image(s) to be printed and one or more character string(s) or grammatical structure(s) that are suggestive of (but are not too obvious) the user authentication credential, can be employed as a reminder of the user authentication credential.

For instance, a rebus, an allusional device, can use one or more images to allude to words or parts of words, which devices have been traditionally used to denote surnames. In such traditional uses, images of animals or other items have been used as a symbol to allude to one or more parts of the surname. In the context of the disclosed subject matter, similar allusions can be employed in printing the one or more image(s) to suggest the correlations between the one or more image(s) to be printed and one or more character string(s) or grammatical structure(s), and which allusions can be suggestive of the user authentication credential. As a non-limiting example, images associated with the words “free,” “bee,” and “ear” can allude to the one or more character string(s) or grammatical structure(s), “‘free’+‘bee’+r+4+a+y+‘ear’,” where a user authentication credential might take one of the forms, “free beer for a year”, “free beer 4 a year”, and so on, etc.

In yet another non-limiting example, as described below regarding FIG. 12, for example, one or more image(s) presented or displayed via a user interface can be presented or displayed in a row of the one or more image(s). However, in still other non-limiting examples, the one or more image(s) presented or displayed via the user interface can be presented or displayed via a “dial” interface analogous to a combination lock or safe dial, rather than a “drum” interface, as described herein regarding FIG. 12, for instance. As a non-limiting example related to recovery of a user authentication credential, a user can select one of the number of “digits” of a user authentication credential (e.g., a user authentication credential that facilitates recovery of a second user authentication credential, etc.) by spinning a lock “dial” interface left or counter-clockwise to select the first digit, then right or clockwise, to the select the next “digit,” and so on, alternating as with the operation of a combination lock or safe dial to complete a selection. In yet other non-limiting aspects, one or more location(s) or order of the images on the “dial” (e.g., the “numbers” on the dial) for one or more of the digits can be presented in a random fashion, which can result in one or more different location(s) or order for the images for subsequent instantiations of the “dial” interface. Likewise, for row or “drum” interface embodiments, one or more location(s) or order of the images of the “digits” can be randomized. In such alternative embodiments, such randomization can advantageously increase security of the various embodiments by making spurious correct guesses of a user authentication credential more difficult.

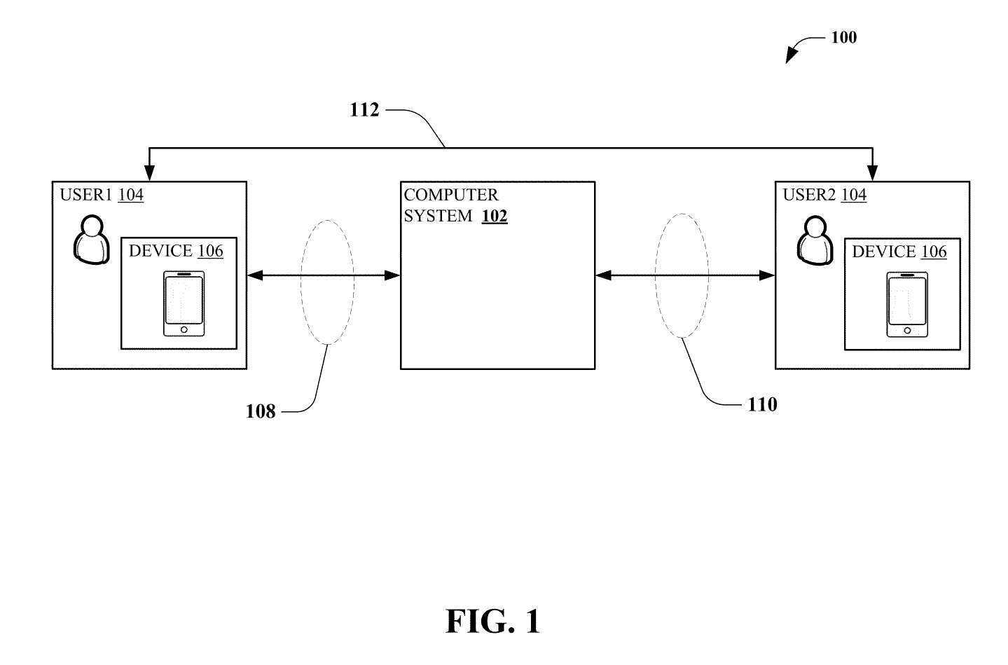

While a brief overview of non-limiting examples has been provided, the following discussion is intended to provide a general description of exemplary environments suitable for use with aspects of the disclosed subject matter. For example, FIGS. 1-3 demonstrate various aspects of the disclosed subject matter. For instance, FIG. 1 depicts a functional block diagram illustrating an exemplary environment 100 suitable for use with aspects of the disclosed subject matter. For instance, FIG. 1 illustrates a computer system 102 in communication with user1 104 and user 2 104, each of which users can be associated with respective devices 106. As further described herein, device 106, as well as computer system 102, can be equipped with a display and a user interface, can facilitate accepting or receiving user input, and/or can facilitate generating, storing, and/or transmitting a user authentication credential to facilitate various aspects as described herein. In addition, as can be understood, communications of user1 104 (108) and user 2 104 (110) with computer system 102 can be electronic or otherwise (e.g., user local manual input and display at computer system 102, via device 106, or any combination thereof including facilitation of aspects by intermediary or agent devices, etc.) as can communications 112 of user1 104 and user 2 104.

Thus, FIG. 1 illustrates a simple exemplary environment 100, in which user1 104 and user2 104 can desire to access computer system 102, for example. For instance, computer system 102 can be associated with a user's (e.g., user1 104 and/or user2 104) financial institution, telecommunications service provider, entertainment or informational service provider, a vendor website, a retailer website, an auction or classified advertisement website, and so on, without limitation, where computer system 102 is to be accessed by user1 104 and/or user2 104 after requiring the generation of a user authentication credential and/or user authentication via a challenge for the user's user authentication credential. Similarly, devices 106, associated with users (e.g., user1 104 and/or user2 104), can be any device where a device 106 is to be accessed by user1 104 and/or user2 104, respectively, after requiring the generation of a user authentication credential and/or user authentication via a challenge for the user's user authentication credential.

As described above, users are typically authenticated to computer system 102 and/or device 106 prior to being granted access (e.g., initial access, enhanced privilege access, access to personal information or special services available on computer system 102 or device 106, access to restricted access systems, devices, or information, etc.). This authentication can be accomplished via a password or user authentication credential presented based on a challenge as described above, or otherwise (e.g., biometric, electronic token, etc.). In the context of the disclosed subject matter, computer system 102 and/or device 106 can provide an opportunity to a user (e.g., user1 104 and/or user2 104) to generate a password or user authentication credential for access to computer system 102 (or device 106, or other devices or systems, etc.), authenticate the respective user via the generated password or user authentication credential, and/or allow recovery of a lost or forgotten password or user authentication credential via a series or a plurality of images presented or displayed to the user (e.g., user1 104 and/or user2 104), and so on according to aspects of the disclosed subject matter as described herein.

By way of non-limiting example, in facilitating access to computer system 102, for instance, a series or plurality of images presented or displayed to the user (e.g., user1 104 and/or user2 104) can be presented or displayed via a user interface of device 106, directly from computer system 102 to the user (e.g., from a user interface of computer system 102 to user1 104 and/or user2 104), via an intermediary (e.g., from computer system 102 via user2 104, or one or more device(s) 106 associated therewith, to user1 104 or one or more device(s) 106 associated therewith, etc.), or otherwise. In further non-limiting implementations, device 106 can provide an opportunity to a user (e.g., user1 104 and/or user2 104) to generate a password or user authentication credential that can facilitate access to device 106 (or computer system 102, or other devices or systems, etc.), authenticate the respective user via the generated password or user authentication credential, which can be stored or transmitted, can facilitate recovery of a lost or forgotten password or user authentication credential via the series or plurality of images presented to the user (e.g., user1 104 and/or user2 104), can facilitate resetting a user authentication credential, can facilitate permitting access to restricted access devices, systems, or information, and/or can allow access to other user authentication credentials according to aspects of the disclosed subject matter as described herein.

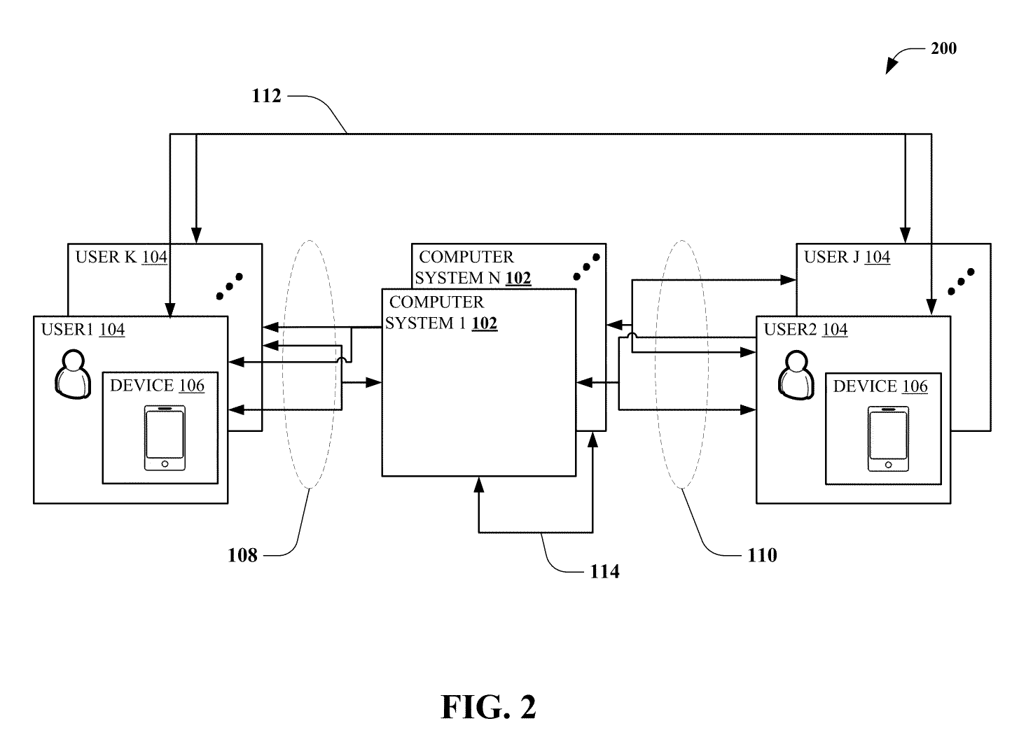

For instance, FIG. 2 depicts another functional block diagram illustrating an exemplary environment 200 and demonstrating further non-limiting aspects of the disclosed subject matter. Moreover, FIG. 2 depicts the more likely scenario with more than one computer system 102, where one or more computer system(s) or devices can act as intermediaries or agents on behalf of user 104 and/or computer system 102 to facilitate displaying or presenting a series or a plurality of images, accepting or receiving user input, generating, storing transmitting, and/or verifying a user authentication credential, and so on, etc. Thus, while user (e.g., user 104) interactions with an exemplary interface (e.g., of device 106, computer system 102, etc.) would likely appear, from a user's perspective to be functionally occurring within the machine associated with the user interface (e.g., of device 106, computer system 102, etc.), it can be understood that various functionality (e.g., storage of user authentication credentials, storage of sets of images to be displayed or presented, accepting or receiving user input comparisons of and verifications of user input with stored user authentication credentials, transmission of associated data, and so on, etc.) can be facilitated or provided by one or more other device(s).

As a non-limiting example, in the simple case of a user authentication credential according to the disclosed subject matter employed as a device (e.g., of device 106, etc.) PIN (or a local computer system 102 account password for a personal computer, etc.), the machine associated with the user interface (e.g., of device 106, computer system 102, etc.) can, indeed, include the requisite functionality to employ user authentication credentials as described herein (e.g., storage of user authentication credentials, storage of sets of images to be displayed or presented, generating, displaying or presenting images, accepting or receiving user input, comparisons of and verifications of user input with stored user authentication credentials, transmitting of associated data, and so on, etc.) and supporting functionality. However, in a more complex example, such as in an exemplary situation requiring logging on to an account of financial institution via a web browser application on a user's smart phone over a cellular wireless service provider's network, it can understood that it would be prudent or perhaps necessary as a security consideration to provide some separation of the various functionality employed (e.g., storage of user authentication credentials, storage of sets of images to be displayed or presented, and/or comparisons of and verifications of user input with stored user authentication credentials, versus displaying or presenting images, accepting or receiving user input, and/or transmitting associated data, and so on, etc.) according to various aspects of the disclosed subject matter. Thus, it can be understood that various functionality as described herein, and/or portions thereof can be provided or facilitated by one or more of device 106, computer system 102, and/or other computer executable agents or intermediaries of device 106 and computer system 102.

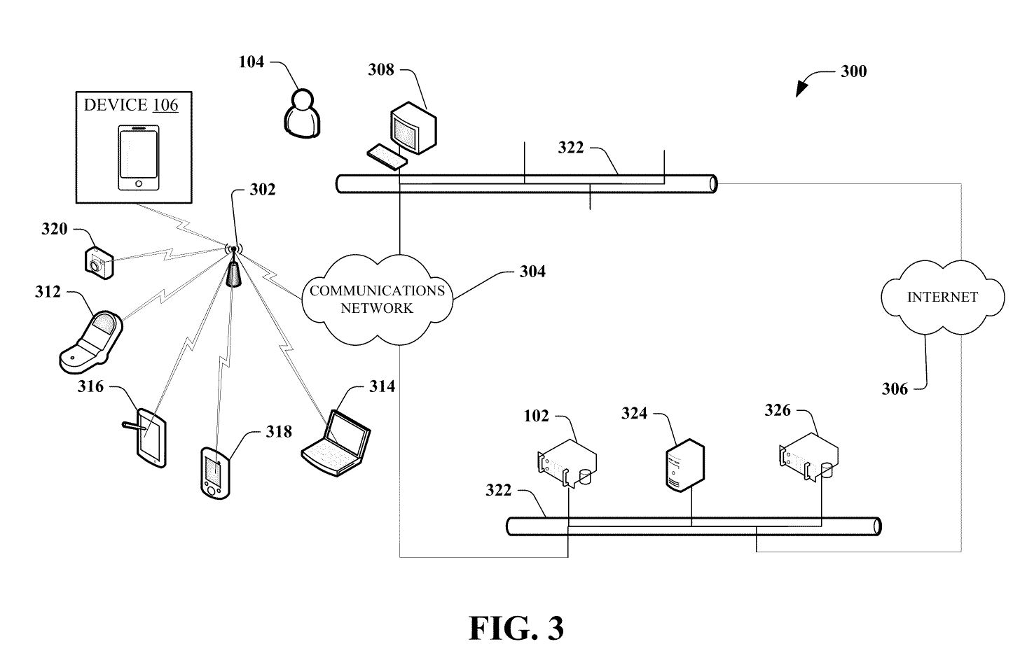

In a non-limiting example, FIG. 3 illustrates an overview of an exemplary computing environment 300 suitable for incorporation of embodiments of the disclosed subject matter. For example, computing environment 300 can comprise wired communication environments, wireless communication environments, and so on. As a further example, computing environment 300 can further comprise one or more of a wireless access component 302, communications networks 304, the internet 306, etc., with which a user 104 can employ any of a variety of devices 106 (e.g., device 308, mobile devices 312-320, and so on to communicate information over a communication medium (e.g., a wired medium 322, a wireless medium, etc.) according to an agreed protocol to facilitate user authentication and/or user authentication credential generation techniques as described herein.

Accordingly, computing environment 300 can comprise a number of components to facilitate user authentication and/or user authentication credential generation according to various aspects of the disclosed subject matter, among other related functions. While various embodiments are described with respect to the components of computing environment 300 and the further embodiments more fully described below, one having ordinary skill in the art would recognize that various modifications could be made without departing from the spirit of the disclosed subject matter. Thus, it can be understood that the description herein is but one of many embodiments that may be possible while keeping within the scope of the claims appended hereto.

Additionally, while devices 106 (e.g., device 308, mobile devices 312-320, etc.) are shown as a generic, network capable device, device 106 is intended to refer to a class of network capable devices that can one or more of receive, transmit, store, etc. information incident to facilitating various techniques of the disclosed subject matter. Note that device 106 is depicted distinctly from that of device 308, or any of the variety of devices (e.g., devices 312-320, etc.), for purposes of illustration and not limitation.

While for purposes of illustration, user 104 can be described as performing certain actions, it is to be understood that device 106 and/or other devices (e.g., via an operating system, application software, device drivers, communications stacks, etc.) can perform such actions on behalf of user 104. Similarly for users 104 and devices 106, which can be discussed or described as performing certain actions, it is to be understood that computing systems or devices associated with users 104 and devices 106 respectively (e.g., via an operating system, application software, device drivers, communications stacks, etc.) can perform such actions on behalf of users 104 and devices 106.

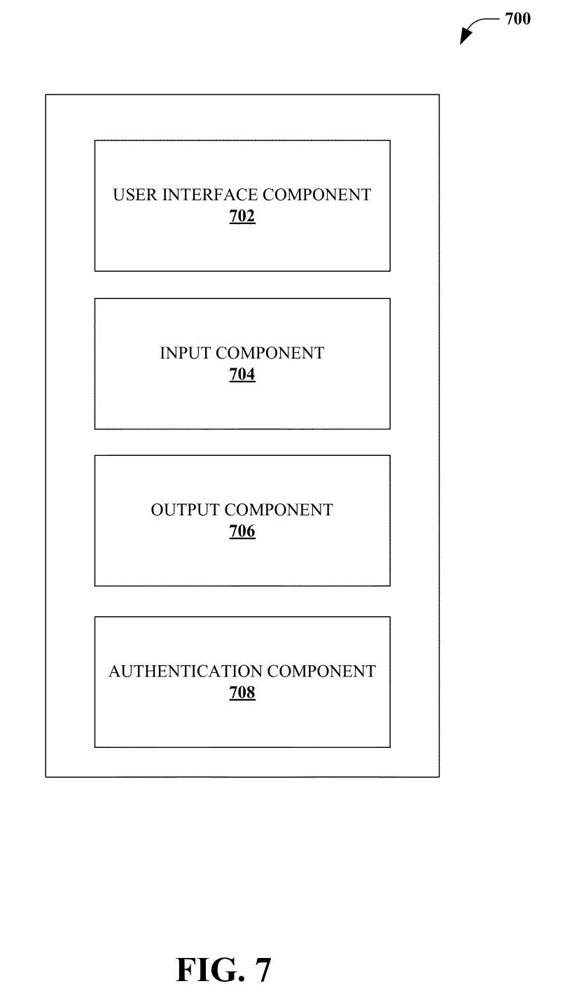

Accordingly, exemplary device 106 can include, without limitation, networked desktop computer 308, a cellular phone 312 connected to a network via access component 302 or otherwise, a laptop computer 314, a tablet personal computer (PC) device 316, and/or a personal digital assistant (PDA) 318, or other mobile device, and so on. As further examples, device 106 can include such devices as a network capable camera 320 and other such devices (not shown) as a pen computing device, portable digital music player, home entertainment devices, network capable devices, appliances, kiosks, and sensors, and so on. It is to be understood that device 106 can comprise more or less functionality than those exemplary devices described above, as the context requires, and as further described below in connection with FIGS. 7-12. According to various embodiments of the disclosed subject matter, the device 106 can connect to other devices and/or computer systems to facilitate accomplishing various functions as further described herein. In addition, device 106 can connect via one or more communications network(s) 304 to a wired network 322 (e.g., directly, via the internet 306, or otherwise).

Wired network 322 (as well as communications network 304) can comprise any number of computers, servers, intermediate network devices, and the like to facilitate various functions as further described herein. As a non-limiting example, wired network 322 can include one or more computer system 102 system(s) (e.g., one or more appropriately configured computing device(s) associated with, operated by, or operated on behalf of computer system 102, etc.) as described above, that can facilitate user authentication and/or user authentication credential generation on behalf of computer system 102, for instance.

In further non-limiting implementations, a communications provider systems 324 can facilitate providing communication services (e.g., web services, email, SMS or text messaging, MMS messaging, Skype®, IM such as ICQ™, AOL® IM or AIM®, etc., Facebook™, Twitter™, IRC, etc.), and which can employ and/or facilitate user authentication and/or user authentication credential generation techniques according to various non-limiting aspects as described herein.

As a further non-limiting example, wired network 322 can also include systems 326 (e.g., one or more appropriately configured computing device(s) associated with, operated by, or operated on behalf of computer system 102, or otherwise for the purpose of user authentication, user authentication credential generation, presenting or displaying a series or a plurality of images, and/or accepting or receiving user input, transmitting, storing, and/or verifying user authentication credentials, and so on, as further described herein, as well as ancillary or supporting functions, etc.).

In addition, wired network 322 or systems (or components) thereof can facilitate performing ancillary functions to accomplish various techniques described herein. For example, in wired network 322 or systems (or components) thereof, functions can be provided that facilitate authentication and authorization of one or more of user 104, device 106, presentation of information via a user interface to user 104 concerning user authentication and/or user authentication credential generation, etc. as described below. In a further example, computing environment 300 can comprise such further components (not shown) (e.g., authentication, authorization and accounting (AAA) servers, e-commerce servers, database servers, application servers, etc.) in communication with one or more of computer system 102, communications provider systems 324, and/or systems 326, and/or device 106 to accomplish the desired functions or to provide additional services for which the techniques of user authentication and/or user authentication credential generation are employed.

In view of the exemplary embodiments described supra, methods that can be implemented in accordance with the disclosed subject matter will be better appreciated with reference to the flowcharts of FIGS. 4-6. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media.

### Exemplary Methods

FIGS. 4-6 depict flowcharts of exemplary methods according to particular non-limiting aspects of the subject disclosure. For instance, FIG. 4 depicts a flowchart of exemplary methods 400, according to particular aspects of the subject disclosure. In FIG. 4, non-limiting methods 400 for generating a user authentication credential are exemplified. For instance, at 402 sets of images can be presented (e.g., to a user, user 104, etc.) via a user interface of a computer (e.g., computer system 102, device 106, etc.), as further described herein regarding FIGS. 11-12, for example. As a non-limiting example, methods 400 can include presenting one or more of the set(s) of images where the set(s) can comprise ten images per set. In a further non-limiting example, methods 400 can further include presenting one or more of the set(s) of images, one image per set at a time, based on a random or pseudo-random determination of images to be presented, as further described herein. In another non-limiting example, the one or more set(s) of images can comprise any number of images, where the one or more set(s) can be understood to correspond to the logical representation of the “digits” of the “drum” as further described above. Furthermore, one or more of the set(s) of images, can be presented or displayed, one image per set at a time, where the presenting or displaying one image per set at a time can correspond to the logical representation of presenting or displaying the images of the image cells of the “digits” of the drum as further described herein regarding FIGS. 1-3. Moreover, one or more image(s) of the image cell or one image per set presented or displayed at a time, can be presented or displayed according to a random or pseudo-random determination of images to be presented or displayed as further described herein.

For instance, in exemplary methods 400, the presenting can include presenting the sets of images in a row of images, such as in the drum analogy described above and below regarding FIG. 12, for example. Thus, presenting the sets of images in a row of images can facilitate scrolling one or more image(s) of the row of images to allow viewing alternate images in one or more of the set(s) of images. In further non-limiting implementations of methods 400, scrolling can include one or more of manual scrolling (e.g., by a user, by user 104, etc.) or automated scrolling by the user interface. Accordingly, the sets of images in a row of images can be manually or automatically scrolled to allow viewing alternate images in one or more of the set(s) of images.

Additionally, in further non-limiting implementations of exemplary methods 400, presenting sets of images can also include generating one or more set(s) of images from a second set of images based on a random or pseudo-random selection of images to be presented in the sets of images. Thus, one or more of the set(s) of images can comprise a subset of images from the second set of images.

Moreover, at 402, methods 400 can further include presenting the sets of images, where one or more of the set(s) of images can be associated with disparate parts of speech (e.g., one a number of disparate parts of speech, one of three disparate parts of speech, etc.). For instance, in further non-limiting implementations of methods 400, presenting the sets of images can include presenting one or more of the set(s) of images based on determining which of the disparate parts of speech (e.g., subject, verb, and adverb, and so on, etc.) associated with the sets of images is to be presented (e.g., via a language processing algorithm, etc.). In still further non-limiting embodiments of methods 400, presenting the sets of images can also include presenting the sets of images, where one or more image(s) of the sets of images can comprise one or more sub-image(s), and where one or more of the one or more sub-image(s) can be associated with one of the number of disparate parts of speech.

In other non-limiting implementations of methods 400, at 402, the presenting can include presenting respective labels associated with the sets of images, where one or more of the respective label(s) can be associated with a subset of the number of disparate parts of speech (e.g., subject, verb, and adverb, and so on, etc.). For instance, any of the images of the sets of images can be associated with a label (e.g., tree, cat, dog, boy, plane, house, etc.), which in turn can be associated with a subset of the number of disparate parts of speech (e.g., noun or subject, etc.). In addition, the presenting the sets of images can further include presenting one or more further set(s) of images associated with an additional disparate part of speech. For instance, additional disparate parts of speech can include one or more of an adjective, a pronoun, a complement, a direct object, an indirect object, a preposition, an object of the preposition, or other parts of speech, and the one or more further set(s) of images associated with such additional disparate parts of speech can be presented at 402, in methods 400.

In addition, at 404, methods 400 can further include receiving input that indicates a selection of a subset of images of the sets of images, where the selection can correspond to a grammatical structure, as further described herein, regarding FIGS. 11-12, for instance. In various non-limiting examples of methods 400, receiving input can include receiving a character string comprising the grammatical structure such as a subject, a verb, and an adverb, as further described herein regarding FIGS. 11-12, for example. In addition, in further non-limiting examples of methods 400, the receiving input can also include receiving a combination of an image of the selection and a subset of the grammatical structure, as further described above. For still further non-limiting implementations, at 404, methods 400 can include receiving input comprising the grammatical structure, or portions thereof, that can include one or more of an adjective, a pronoun, a complement, a direct object, an indirect object, a preposition, or an object of the preposition.

At 406, methods 400 can include a determination as to whether a user rejects the sets of images (e.g., because a user desires a different series or combination of images, etc.). For example, a particular series or combination of images may provide a user an uninteresting sample of images for which to derive a memorable user authentication credential. In addition, at 408, methods 400 can include a determination as to whether there is an applicable requirement pending to reset the user authentication credential. For instance, due to security policies associated with a system or device, due to administrative intervention, or otherwise, a requirement can be specified that a user authentication credential should be reset. Additionally, at 410, methods 400 can include a determination as to whether passage of a predetermined period of time has occurred. As a non-limiting example, security policies associated with a system can specify that a user authentication credential should expire after passage of a predetermined period of time, which can present another opportunity to generate a user authentication credential.

Otherwise, at 412, methods 400 can comprise storing or transmitting one or more of the selection or the grammatical structure as the user authentication credential as further described herein, regarding FIGS. 11-12, for example. For instance, in exemplary embodiments of methods 400, the storing or transmitting the selection or the grammatical structure as the user authentication credential can facilitate one or more of permitting access to a restricted access system, permitting access to a restricted access device, comparing the user authentication credential to a stored user authentication credential, resetting the stored user authentication credential to a reset user authentication credential, determining that a user (e.g., user 104, etc.) is authorized to access a second user authentication credential, or granting access to restricted access information, as further described herein, regarding FIGS. 1-3, for example. As a further non-limiting embodiment of methods 400, comparing the user authentication credential to the stored user authentication credential can include determining that a user (e.g., user 104, etc.) is authorized to access the second user authentication credential.

In the instance that one or more of the determination(s) at 406, 408, or 410 justify an additional presentation of sets of images, second sets of images can be presented. Thus, at 414 methods 400 can further include presenting second sets of images based on one or more of a rejection by a user (e.g., user 104, etc.) of the sets of images, a requirement to reset the user authentication credential, passage of a predetermined period of time, etc., as described. Accordingly, at 416, methods 400 can also include receiving the input based on the second sets of images. That is, methods 400 can include receiving input that indicates a selection of a subset of images of the second sets of images, where the selection can correspond to a grammatical structure, as further described herein, regarding FIGS. 11-12. In addition, at 418, methods 400 can include storing or transmitting the user authentication credential based on the second sets of images.

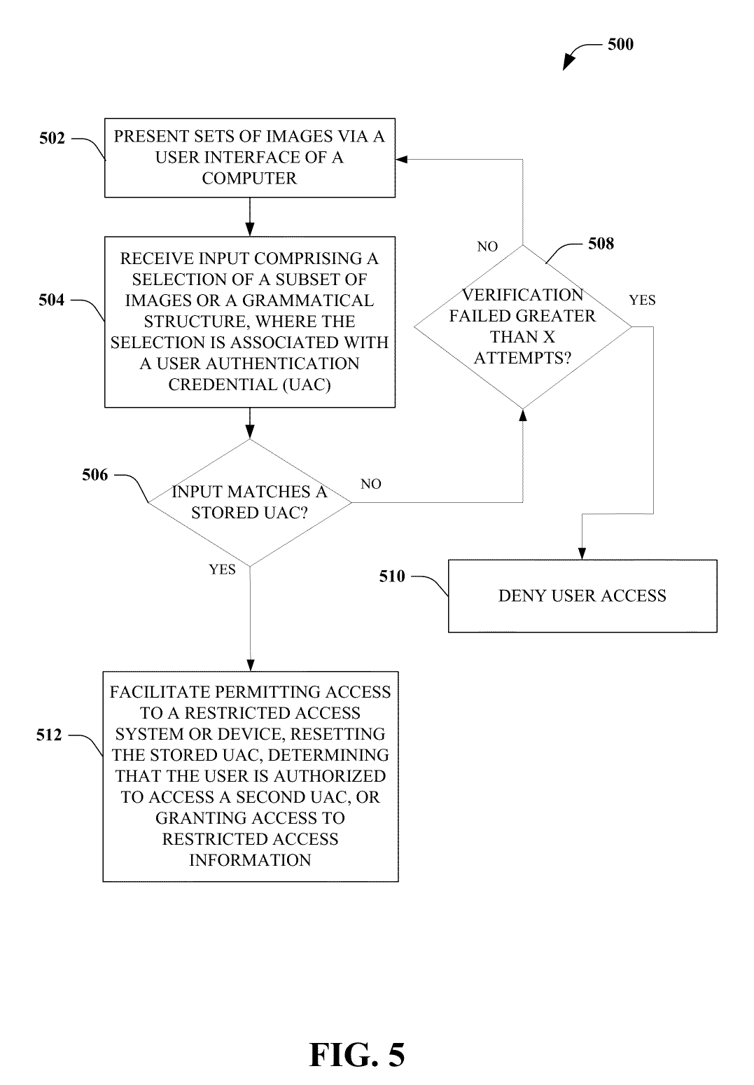

FIGS. 5-6 depict further exemplary flowcharts of exemplary methods according to still further non-limiting aspects of the disclosed subject matter. For instance, FIGS. 5-6 depict exemplary flowcharts of methods 500 and 600 facilitating user authentication. At 502, methods 500 can comprise presenting sets of images to a user (e.g., user 104, etc.) via a user interface of a computer (e.g., computer system 102, device 106, etc.), as further described herein regarding FIGS. 11-12, for example. For instance, in exemplary methods 500, the presenting can include presenting the sets of images in a row of images, as described above. Thus, presenting the sets of images in a row of images can facilitate scrolling one or more image(s) of the row of images to allow viewing alternate images in the one or more of the set(s) of images. In further non-limiting implementations of methods 500, scrolling can include manual scrolling (e.g., by a user, by user 104, etc.), such that the sets of images in a row of images can be manually scrolled to allow viewing alternate images in one or more of the set(s) of images.

In addition, at 502, methods 500 can also include presenting the sets of images, where one or more of the set(s) of images can be associated with disparate parts of speech (e.g., one a number of disparate parts of speech, one of three disparate parts of speech, etc.). For instance, in further non-limiting embodiments of methods 500, presenting the sets of images can include presenting one or more of the set(s) of images based on determining which of the disparate parts of speech associated with the sets of images is to be presented (e.g., via a language processing algorithm, etc.). In yet other non-limiting implementations of methods 500, presenting the sets of images can also include presenting the sets of images, where one or more image(s) of the sets of images can comprise one or more sub-image(s), and where one or more of the one or more sub-image(s) can be associated with one of the number of disparate parts of speech, as further described herein, for example, regarding FIGS. 11-12.

Moreover, in other non-limiting embodiments of methods 500, at 502, the presenting can include presenting respective labels associated with the sets of images, where one or more of the respective label(s) can be associated with a subset of the number of disparate parts of speech. As an example described above, any of the sets of images can be associated with a label (e.g., tree, cat, dog, boy, plane, house, etc.), which in turn can be associated with a subset of the number of disparate parts of speech (e.g., noun or subject, etc.). Additionally, presenting the sets of images can further include presenting one or more further set(s) of images associated with an additional disparate part of speech. As a non-limiting embodiment, additional disparate parts of speech can include one or more of an adjective, a pronoun, a complement, a direct object, an indirect object, a preposition, an object of the preposition, and the one or more further set(s) of images associated with such additional disparate parts of speech can be presented at 502, in various non-limiting embodiments of methods 500.

In addition, at 504, methods 500 can also comprise receiving input comprising one or more of a selection of a subset of images of the sets of images or a grammatical structure, where the selection can be associated with a user authentication credential, as further described herein. In addition, in further non-limiting examples of methods 500, the receiving input can also include receiving a combination of an image of the selection and a subset of the grammatical structure, as further described above. In yet other non-limiting implementations, at 504, methods 500 can include receiving input comprising the grammatical structure that can include one or more of an adjective, a pronoun, a complement, a direct object, an indirect object, a preposition, or an object of the preposition, and so on, as described herein.

Moreover, at 506, methods 500 can further include a determination as to whether the input matches a stored user authentication credential. For instance, methods 500 can also include verifying the input matches a stored user authentication credential. In addition, at 508, methods 500 can include a determination as to whether the verification has failed greater than a predetermined number, X, attempts. For instance, due to security policies associated with a system or device (e.g., computer system 102, device 106, etc.), a user (e.g., user 104, etc.) can be limited in the number of attempts at verifying the input matches a stored user authentication credential, before administrative intervention, or other manual or automated action (e.g., account lockout, user authentication credential recovery, user authentication credential etc.) is implemented. If it is determined that the input does not match the stored user authentication credential at 506, methods 500 can include denying user access, at 510, based on the determining that the input that does not match (e.g., after a predetermined number of attempts, etc.). Otherwise, at 512 non-limiting examples of methods 500 can facilitate one or more of permitting access to a restricted access system, permitting access to a restricted access device, resetting the stored user authentication credential to the reset user authentication credential, determining that a user (e.g., user 104, etc.) is authorized to access a second user authentication credential, or granting access to restricted access information, as further described herein, regarding FIGS. 1-3, for example.

In further non-limiting embodiments of the disclosed subject matter, FIG. 6 depicts an exemplary flowchart of methods 600 of user authentication, to facilitate, among other tasks, resetting a user authentication credential, for example, as described above. For instance, at 602, methods 600 can comprise presenting sets of images to a user (e.g., user 104, etc.) via a user interface of a computer (e.g., computer system 102, device 106, etc.), as further described herein regarding FIGS. 11-12, for example. In exemplary methods 600, the presenting can include presenting the sets of images in a row of images, as an example. Thus, presenting the sets of images in a row of images can facilitate scrolling one or more image(s) of the row of images to allow viewing alternate images in one or more of the set(s) of images. In further non-limiting implementations of methods 600, scrolling can include manual scrolling (e.g., by a user, by user 104, etc.), such that the sets of images in a row of images can be manually scrolled to allow viewing alternate images in one or more of the set(s) of images.

In addition, at 602, methods 600 can also include presenting the sets of images, where one or more of the set(s) of images can be associated with disparate parts of speech (e.g., one a number of disparate parts of speech, one of three disparate parts of speech, etc.). For instance, in further non-limiting embodiments of methods 600, presenting the sets of images can include presenting one or more of the set(s) of images based on determining which of the disparate parts of speech associated with the sets of images is to be presented (e.g., via a language processing algorithm, etc.). In yet other non-limiting implementations of methods 400, presenting the sets of images can also include presenting the sets of images, where one or more image(s) of the sets of images can comprise one or more sub-image(s), and where one or more of the one or more sub-image(s) can be associated with one of the number of disparate parts of speech.

Moreover, in other non-limiting embodiments of methods 600, at 602, the presenting can include presenting respective labels associated with the sets of images, where one or more of the respective label(s) can be associated with a subset of the number of disparate parts of speech. As an example described above, any of the sets of images can be associated with a label (e.g., tree, cat, dog, boy, plane, house, etc.), which in turn can be associated with a subset of the number of disparate parts of speech (e.g., noun or subject, etc.), as described above. Additionally, presenting the sets of images can further include presenting one or more further set(s) of images associated with an additional disparate part of speech. As a non-limiting embodiments, additional disparate parts of speech can include one or more of an adjective, a pronoun, a complement, a direct object, an indirect object, a preposition, an object of the preposition, and so on, and the one or more further set(s) of images associated with such additional disparate parts of speech can be presented at 602, in various non-limiting embodiments of methods 600.

In addition, at 604, methods 600 can also comprise receiving input comprising one or more of a selection of a subset of images of the sets of images or a grammatical structure, where the selection can be associated with a user authentication credential, as further described herein. In addition, in further non-limiting examples of methods 600, the receiving input can also include receiving a combination of an image of the selection and a subset of the grammatical structure, as further described above. In yet other non-limiting implementations of methods 600, at 604, methods 600 can include receiving input comprising the grammatical structure that can include one or more of an adjective, a pronoun, a complement, a direct object, an indirect object, a preposition, or an object of the preposition, as further described herein, for example, regarding FIGS. 11-12.

Moreover, at 606, methods 600 can further include a determination as to whether the input matches a stored user authentication credential. For instance, methods 600 can also include verifying the input matches a stored user authentication credential. In addition, at 608, methods 600 can include a determination as to whether the verification has failed greater than a predetermined number, X, attempts. For instance, due to security policies associated with a system, a user can be limited in the number of attempts at verifying the input matches a stored user authentication credential, before administrative intervention, or other manual or automated action (e.g., account lockout, user authentication credential recovery, user authentication credential etc.) is implemented. If it is determined that the input does not match the stored user authentication credential at 606, methods 600 can include denying user access, at 610, based on the determining that the input that does not match (e.g., after a predetermined number of attempts, etc.).

In addition, at 612, methods 600 can include a determination as to whether there is an applicable requirement to reset the user authentication credential. For instance, as described above, due to security policies associated with a system or device (e.g., computer system 102, device 106, etc.), administrative intervention, or otherwise, a requirement can be specified that a user authentication credential should be reset. Moreover, at 614, methods 600 can include a determination as to whether passage of a predetermined period of time has occurred. As a non-limiting example, security policies associated with a system or device (e.g., computer system 102, device 106, etc.) can specify that a user authentication credential should expire after passage of a predetermined period of time, which can present another opportunity to generate a user authentication credential. Otherwise, at 616 non-limiting examples of methods 600 can facilitate one or more of permitting access to a restricted access system, permitting access to a restricted access device, resetting the stored user authentication credential to the reset user authentication credential, determining that a user (e.g., user 104, etc.) is authorized to access a second user authentication credential, or granting access to restricted access information, as further described herein, regarding FIGS. 1-3, for example.

As a non-limiting example of facilitating access to a restricted access system or device (e.g., computer system 102, device 106, etc.) such as an Automated Teller Machine (ATM), point of sale (POS) terminal, and/or a mobile device, and so on, consider a user (e.g., user 104, etc.) attempting to remember an ATM PIN. Various embodiments as described herein can facilitate permitting access to a restricted access system or device. In a further non-limiting example, PINs or other user authentication credentials can be stored, transmitted, and/or verified employing various aspects of the disclosed subject matter to facilitate permitting access to a restricted access system or device. In yet another non-limiting example, one or more PINs or other user authentication credentials can be stored on a system or device (e.g., computer system 102, device 106, etc.), and exemplary embodiments of the disclosed subject matter (e.g., presenting or displaying images, accepting or receiving user input, verifying, storing, and/or transmitting, etc.) can be employed to recover, verify, and/or transmit such user authentication credentials to another system or device (e.g., computer system 102, device 106, etc.), such as in an exemplary implementation of an ATM PIN stored on a mobile device. Thus, various non-limiting implementations can flexibly and securely facilitate password recovery via mobile device (e.g., device 106, etc.), as well as other convenient and secure options for use of user authentication credentials, whether in traditional form or otherwise according to aspects of the disclosed subject matter, across multiple systems and devices.

In the instance that one or more of the determination(s) at 606, 612, or 614 justify an additional presentation of sets of images, second sets of images can be presented. Thus, at 618 methods 600 can further include presenting second sets of images based on one or more of a rejection (e.g., by a user, by user 104, etc.) of the plurality of sets of images, a requirement to reset the user authentication credential, passage of a predetermined period of time, etc., as described. As described above regarding FIG. 4, at 618, methods 600 can further include presenting the second sets of images, where one or more of the second set(s) of images can be associated with disparate parts of speech (e.g., one a number of disparate parts of speech, one of three disparate parts of speech, etc.). For instance, in further non-limiting embodiments of methods 600, presenting the second sets of images can include presenting one or more of the second set(s) of images based on determining which of the disparate parts of speech associated with the second sets of images is to be presented (e.g., via a language processing algorithm, etc.). In other non-limiting implementations of methods 600, presenting the second sets of images can also include presenting the second sets of images, where one or more image(s) of the second sets of images can comprise one or more sub-image(s), and where one or more of the one or more sub-image(s) can be associated with one of the number of disparate parts of speech.

Accordingly, at 620, methods 600 can also include receiving the input based on the second sets of images. That is, methods 600 can include receiving input that indicates a selection of a subset of images of the second sets of images, where the selection can correspond to a grammatical structure, as further described herein, for example, regarding FIGS. 11-12. In further non-limiting examples of methods 600, receiving input can also include receiving a combination of an image of the selection and a subset of the grammatical structure, as further described above. In addition, at 622, methods 600 can include storing or transmitting the user authentication credential based on the second sets of images.

In view of the methods described supra, systems and devices that can be implemented in accordance with the disclosed subject matter will be better appreciated with reference to the functional block diagrams of FIGS. 7-16. While, for purposes of simplicity of explanation, the functional block diagrams are shown and described as various assemblages of functional component blocks, it is to be understood and appreciated that such illustrations or corresponding descriptions are not limited by such functional block diagrams, as some implementations may occur in different configurations. Moreover, not all illustrated blocks may be required to implement the systems and devices described hereinafter.

### Exemplary Systems and Apparatuses

FIG. 7 depicts a non-limiting block diagram of exemplary systems 700 according to various non-limiting aspects of the disclosed subject matter. As a non-limiting example, systems 700 can comprise a user interface component 702, an input component 704, an output component 706, and/or an authentication component 708, as well as other ancillary and/or supporting components, and/or portions thereof, as described herein. For instance, as described herein, exemplary systems 700 can comprise systems (e.g., computer system 102, device 106, etc.), that facilitate creating a user authentication credential and/or user authentication.

Thus, in exemplary non-limiting implementations (e.g., systems 700 that facilitate creating a user authentication credential), user interface component 702 can be configured to display a series of images to a user (e.g., user 104, etc.), as further described herein, for example, regarding FIGS. 11-12. According to various non-limiting embodiments of the disclosed subject matter, user interface component 702 can be further configured to display one or more of the series of images based on a random or pseudo-random determination of images to be displayed, as described above regarding FIG. 4-6, for instance. In a further example, as described herein, user interface component 702 can also be configured to generate one or more of the series of image(s) from a collection of images based on random or pseudo-random selection of one or more image(s) to be displayed in the one or more of the series of image(s), where the one or more of the series of image(s) can comprise a subset of images from the collection of images, as further described herein, for example, regarding FIGS. 11-12. In addition, further non-limiting embodiments of the disclosed subject matter, user interface component 702 of systems 700 can be further configured to display the series of images in a row of images. For instance, as described above, displaying the series of images in a row of images can facilitate manual or automated scrolling of one or more image(s) of the row of images, for example, and can allow display of alternate images in one or more of the series of images.

In other non-limiting implementations, the user interface component 702 can be further configured to display a second series of images based on one or more of a rejection (e.g., by a user, by user 104, etc.) of the series of images, a requirement to reset the user authentication credential, or passage of a predetermined period of time, as described above. Additionally, user interface component 702 can be further configured to user interface component 702 can be configured to display a series of images to a user, where one or more of the series of images can be associated with disparate parts of speech, according to further non-limiting aspects, as further described herein, for example, regarding FIGS. 11-12. In a further non-limiting aspect, user interface component 702 can be configured to display a series of images to a user (e.g., user 104, etc.), where one or more image(s) of the series of images can comprise a number of sub-images, and where one or more of the sub-image(s) can be associated with one of the disparate parts of speech, as further described herein, for example, regarding FIGS. 11-12. In addition, further non-limiting implementations of user interface component 702 can be configured to display respective labels associated with the series of images, where one or more of the respective label(s) can be associated with a subset of the disparate parts of speech, as described. Moreover, user interface component 702 can be further configured to display one or more additional image(s) associated with an additional disparate part of speech comprising one or more of an adjective, a pronoun, a complement, a direct object, an indirect object, a preposition, or an object of the preposition, and so on, as described above. Thus, in various non-limiting implementations, user interface component 702, as described, can be further configured to display one or more of the series of images based on a determination of which of the disparate parts of speech associated with the series of images is to be displayed (e.g., via a language processing algorithm, etc.).

In further non-limiting implementations of system 700, input component 704 can be configured to accept input that indicates a selection of a subset of images of the series of images, where the selection corresponds to a grammatical structure, as further described herein, for instance, regarding FIGS. 11-12. As an example, input component 704 can be further configured to accept a combination of an image of the selection and a subset of the grammatical structure, and/or can be configured to accept input, where the grammatical structure can comprise one or more of a subject, a verb, and an adverb, according to further non-limiting aspects. In addition, according to further non-limiting implementations, input component 704 can be further configured to accept the input based on the second series of images, for example. Moreover, input component 704 can be further configured to accept input comprising the grammatical structure comprising one or more of an adjective, a pronoun, a complement, a direct object, an indirect object, a preposition, or an object of the preposition, and so on, according to further exemplary implementation.

In other non-limiting implementations of system 700, output component 706 can be configured to store or transmit one or more of the selection or the grammatical structure as the user authentication credential. Still other non-limiting implementations can comprise output component 706 configured to store or transmit the user authentication credential based on the second series of images.

In addition, in exemplary non-limiting implementations (e.g., systems 700 that facilitate user authentication), user interface component 702 can be configured display a series of images to a user, as further described herein, for example, regarding FIGS. 11-12. According to various non-limiting embodiments of the disclosed subject matter, user interface component 702 can be further configured to display the series of images in a row of images, to facilitate manual scrolling of one or more image(s) of the row of images, for instance, and to allow display of alternate images in one or more of the series of images, as described above regarding FIG. 4-6. In a further example, as described herein, user interface component 702 can also be configured to display the series of images, where one or more of the series of images can be associated with disparate parts of speech, as further described herein, for example, regarding FIGS. 11-12.

In yet other non-limiting embodiments, user interface component 702 can be further configured to display the series of images, where one or more image(s) of the series of images can comprise a number of sub-images, and where one or more of the sub-image(s) can be associated with one of the disparate parts of speech, as further described herein, for example, regarding FIGS. 11-12. For instance, in a non-limiting aspect, user interface component 702 can be further configured to display one or more additional images associated with an additional disparate part of speech comprising one or more of an adjective, a pronoun, a complement, a direct object, an indirect object, a preposition, or an object of the preposition, and so on, as described herein. According to further non-limiting embodiments of system 700, user interface component 702 can be further configured to display the series of images, where one or more image(s) of the series of images can comprise a number of sub-images, and where one or more of the sub-image(s) can be associated with one of the disparate parts of speech, as further described herein, for example, regarding FIGS. 11-12.

In addition, as further described herein, for example, regarding FIGS. 11-12, user interface component 702 can be further configured to display respective labels associated with the series of images, where one or more of the respective label(s) can be associated with a subset of the disparate parts of speech. Moreover, user interface component 702 can be further configured to display a second series of images in response to one or more of a determination (e.g., a determination that the input does not match the stored user authentication credential, and so on etc.), a requirement to reset the stored user authentication credential, or passage of a predetermined period of time, etc.

In further non-limiting implementations of system 700, input component 704 can be configured to accept input comprising one or more of a selection of a subset of images of the series of images or a grammatical structure, where the selection can be associated with a user authentication credential, for instance, as further described herein, for example, regarding FIGS. 11-12. In other non-limiting implementations of system 700, input component 704 can also be configured to accept a character string comprising the grammatical structure including one or more of a subject, a verb, an adverb, and so on, as further described herein, for instance, regarding FIGS. 11-12. Still other non-limiting implementations can comprise input component 704 configured to accept a combination of an image of the selection and a subset of the grammatical structure, as described herein. In addition, according to various non-limiting aspects, the input component 704 can be further configured to accept input comprised of the grammatical structure including one or more of an adjective, a pronoun, a complement, a direct object, an indirect object, a preposition, and/or an object of the preposition, and so on. In yet other non-limiting implementations of system 700, input component 704 can also be configured to accept the input based on the second series of images, as further described herein, for example, regarding FIGS. 11-12.

In addition, authentication component 708 can be configured to verify the input matches a stored user authentication credential. As a non-limiting example, the authentication component 708 can be configured to compare the input to a stored user authentication credential. For instance, authentication component 708 configured to compare the input to a stored user authentication credential can also facilitate permitting access to a restricted access system, permitting access to a restricted access device, resetting the stored user authentication credential to a reset user authentication credential, determining that a user (e.g., user 104, etc.) can be authorized to access a second user authentication credential, transmitting the comparison results, and/or granting access to restricted access information, based on the comparison, and so on, according to further non-limiting aspects.

In still other non-limiting implementations of the disclosed subject matter, an authentication component 708 of system 700 can be further configured to determine that the input does not match the stored user authentication credential. As a non-limiting example, authentication component 708 configured to determine that the input does not match the stored user authentication credential can also facilitate denying access to a restricted access system, denying access to a restricted access device, preventing the stored user authentication credential from being reset, determining that a user (e.g., user 104, etc.) can be not authorized to access a second user authentication credential, transmitting the comparison results, and/or denying access to restricted access information, based on the determination, and so on, according to further non-limiting aspects. In still further non-limiting embodiments, authentication component 708 can be further configured to determine that the input does not match the stored user authentication credential based on a predetermined number of attempts. Thus, authentication component 708 of system 700 can be further configured to verify the input (e.g., input based on the second series of images matches) the stored user authentication credential, store the input as the user authentication credential, and/or transmit the input as the user authentication credential, and so on, as further described herein.

Further discussion of the advantages and flexibility provided by the various non-limiting embodiments can be appreciated by review of the following descriptions.

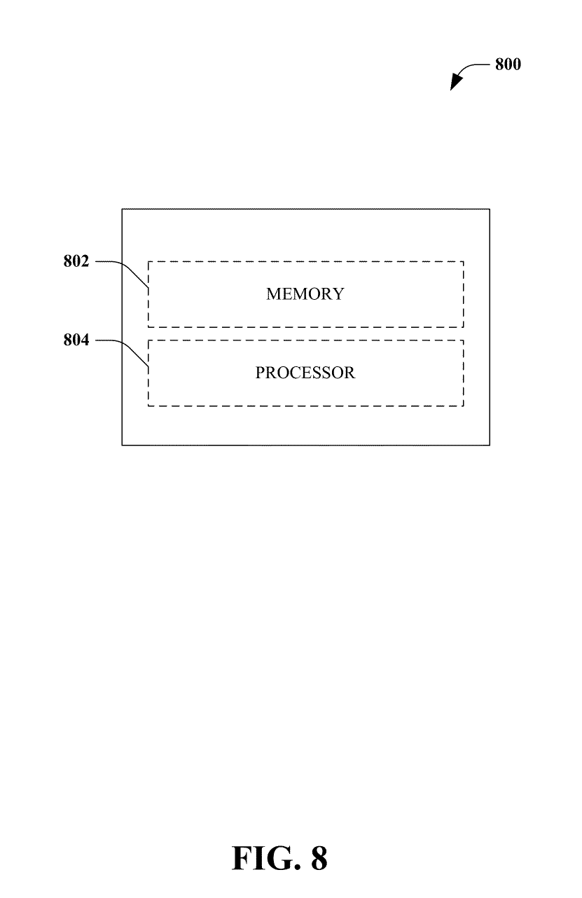

For example, FIG. 8 illustrates an exemplary non-limiting device, component, or system 800 suitable for performing various techniques of the disclosed subject matter. The device, component, or system 800 can be a stand-alone device, component, or system and/or one or more portion(s) thereof or such as a specially programmed computing device or one or more portion(s) thereof (e.g., a memory retaining instructions for performing the techniques as described herein coupled to a processor). Device, component, or system 800 can include a memory 802 that retains various instructions with respect to presenting images to a user (e.g., user 104, etc.), receiving input, storing or transmitting information, verifying input and user authentication credentials, sending and receiving information according to various protocols, performing analytical routines, and/or the like.

For instance, device, component, or system 800 can include a memory 802 that retains instructions for presenting a series of images to a user (e.g., user 104, etc.) via a user interface generated by a computing device (e.g., device, component, or system 800, etc.), as further described herein, for example, regarding FIGS. 11-12. As described above, according to various embodiments, the disclosed subject matter can facilitate generating a user authentication credential, permitting access to a restricted access system or device, comparing the user authentication credential to a stored user authentication credential, resetting the stored user authentication credential, determining that a user (e.g., user 104, etc.) is authorized to access a second user authentication credential, and/or granting access to restricted access information, and the like. For example, memory 802 can retain instructions for determining that a user (e.g., user 104, etc.) is authorized to access a second user authentication credential.

In further non-limiting embodiments, instructions in memory 802 can comprise instructions for presenting the series of images in a row of images. For instance, presenting the series of images in a row of images can facilitate manual or automated scrolling one or more image(s) of the row of images to allow viewing alternate images in one or more of the series of images, as further described herein, for example, regarding FIGS. 11-12. Moreover, instructions in memory 802 can comprise instructions for presenting one or more of the series of images based on a random or pseudo-random determination of images to be presented, instructions for selecting one or more of the series of image(s) from a set of images based on random or pseudo-random selection of an image to be presented in the one or more of the series of image(s), and/or instructions for presenting the series of images, where one or more of the series of images can be associated with one of the disparate parts of speech (e.g., three disparate parts of speech), and so on, as further described herein, for example, regarding FIGS. 11-12.

For example, instructions in memory 802 can comprise instructions for presenting one or more of the series of images based on a language processing algorithm. As an example, presenting one or more of the series of images based on a language processing algorithm can determine or facilitate determining which of the disparate parts of speech associated with the series of images is presented or displayed, constructing nonsensical sentences or turns of phrase based on images and/or respective labels, and so on, etc. In addition, instructions in memory 802 can further comprise instructions for presenting or displaying the series of images, where one or more image(s) of the series of images can comprise one or more sub-image(s), and where one or more of the sub-image(s) can be associated with one of the disparate parts of speech. In further non-limiting implementations, instructions in memory 802 can also comprise instructions for presenting respective labels associated with the series of images, where one or more of the respective label(s) can be associated with a subset of the disparate parts of speech, and/or instructions for presenting one or more additional images associated with an additional disparate part of speech that can comprise one or more of an adjective, a pronoun, a complement, a direct object, an indirect object, a preposition, or an object of the preposition, as further described herein, for example, regarding FIGS. 11-12.

The memory 802 can further retain instructions for receiving input associated with a selection of a subset of images of the series of images, where the selection can correspond to a grammatical structure, as described herein. In further non-limiting implementations, instructions in memory 802 can comprise instructions for receiving a character string comprising the grammatical structure including one or more of a subject, a verb, and an adverb, as further described herein, for example, regarding FIGS. 11-12. In addition, instructions in memory 802 can comprise instructions for receiving or accepting as a selection a combination of an image of the selection and a subset of the grammatical structure. In still further non-limiting embodiments, instructions in memory 802 can comprise instructions for receiving input that can comprise the grammatical structure including one or more of the adjective, the pronoun, the complement, the direct object, the indirect object, the preposition, or the object of the preposition.

Additionally, memory 802 can retain instructions for storing or transmitting one of the selection or the grammatical structure as the user authentication credential. Memory 802 can further include instructions pertaining to presenting a second series of images based on one or more of a rejection (e.g., by a user, by user 104, etc.) of the series of images, a requirement to reset the user authentication credential, or passage of a predetermined period of time; to receiving input based on the second series of images; and/or to storing or transmitting the user authentication credential based on the second series of images. The above example instructions and other suitable instructions can be retained within memory 802, and a processor 804 can be utilized in connection with executing the instructions.

In further non-limiting implementations, device, component, or system 800 can comprise processor 804, and/or computer readable instructions stored on a non-transitory computer readable storage medium (e.g., memory 802, a hard disk drive, and so on, etc.), the computer readable instructions, when executed by a computing device, e.g., by processor 804, can cause the computing device to perform operations, according to various aspects of the disclosed subject matter. As a non-limiting example, the computer readable instructions, when executed by a computing device (e.g., computer system 102, device 106, etc.), can cause the computing device to authenticate a user, and so on, etc., as described herein. For example, in non-limiting implementations of the disclosed subject matter, device, component, or system 800 can include a memory 802 that retains instructions for presenting a series of images to a user (e.g., user 104, etc.) via a user interface generated by the computing device (e.g., device, component, or system 800, computer system 102, device 106, etc.), as further described herein, for example, regarding FIGS. 11-12. As described above, according to various embodiments, the disclosed subject matter can facilitate user authentication, permitting access to a restricted access system or device, resetting a stored user authentication credential to a reset user authentication credential, determining that a user (e.g., user 104, etc.) is authorized to access a second user authentication credential, and/or granting access to restricted access information, and so on.

In further non-limiting embodiments, instructions in memory 802 can comprise instructions for presenting the series of images in a row of images, as further described herein, for example, regarding FIGS. 11-12. As an example, presenting the series of images in a row of images can facilitate manual scrolling of one or more image(s) of the row of images to allow viewing alternate images in one or more of the series of images. In addition, instructions in memory 802 can comprise instructions for presenting the series of images, where one or more of the series of images can be associated with one of the disparate parts of speech. In still further non-limiting implementations, instructions in memory 802 can comprise instructions for presenting the series of images, where one or more image(s) of the series of images can comprise one or more sub-image(s), and where one or more of the sub-image(s) can be associated with one of the disparate parts of speech, and/or instructions for presenting respective labels associated with the series of images, where one or more of the respective label(s) can be associated with a subset of the disparate parts of speech, as further described herein, for example, regarding FIGS. 11-12. In yet other non-limiting implementations, instructions in memory 802 can comprise instructions for presenting one or more additional image(s) associated with an additional disparate part of speech that can comprise one or more of an adjective, a pronoun, a complement, a direct object, an indirect object, a preposition, or an object of the preposition, and so on, as described above.

The memory 802 can further retain instructions for receiving input comprising a selection of a subset of images of the series of images or a grammatical structure, where the selection can be associated with a user authentication credential, as described above. As a non-limiting example, instructions in memory 802 can comprise instructions for receiving a character string comprising the grammatical structure including one or more of a subject, a verb, and an adverb, as further described herein, for instance, regarding FIGS. 11-12. In addition, in further non-limiting embodiments of device, component, or system 800, instructions in memory 802 can comprise instructions for receiving a combination of an image of the selection and a subset of the grammatical structure, as described herein. Moreover, instructions in memory 802 can further comprise instructions for receiving one or more of the adjective, the pronoun, the complement, the direct object, the indirect object, the preposition, or the object of the preposition, and so on, as further described herein, for example, regarding FIGS. 11-12.

Additionally, memory 802 can retain instructions for verifying the input matches a stored user authentication credential. Memory 802 can further include instructions pertaining to presenting a second series of images in response to one or more of determining that the input does not match the stored user authentication credential, a requirement to reset the user authentication credential, or passage of a predetermined period of time; to receiving the input based on the second series of images; to verifying the input matches the stored user authentication credential; to storing the input as the user authentication credential; and/or to transmitting the input as the user authentication credential. Moreover, memory 802 can retain instructions for denying user access based determining that the input that does not match a predetermined number times, as described above.

The above example instructions and other suitable instructions can be retained within memory 802, and a processor 804 can be utilized in connection with executing the instructions.

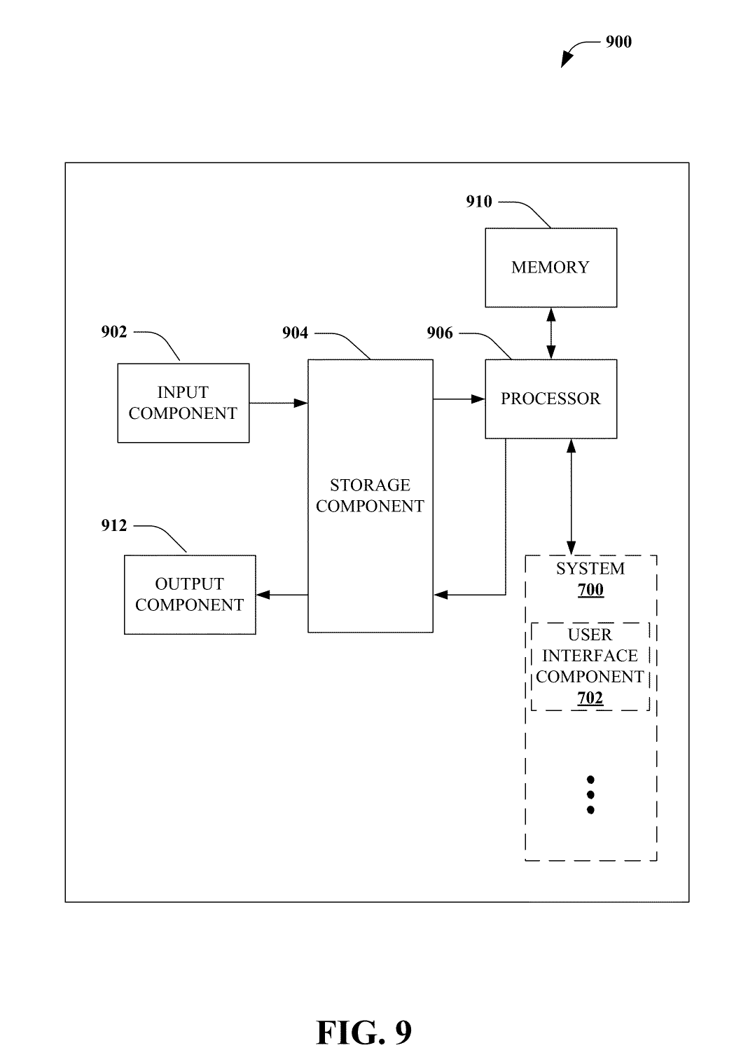

FIG. 9 illustrates non-limiting systems or apparatuses 900 that can be utilized in connection with systems and supporting methods and devices (e.g., computer system 102, device 106, etc.) as described herein. As a non-limiting example, systems or apparatuses 900 can comprise an input component 902 that can receive data, signals, information, feedback, and so on to facilitate presenting images to a user, receiving input, storing or transmitting information, verifying input, sending and receiving information according to various protocols, performing analytical routines, and/or the like, and can perform typical actions thereon (e.g., transmits information to storage component 904 or other components, portions thereof, and so on, etc.) for the received data, signals, information, user authentication credentials etc. A storage component 904 can store the received data, signals, information (e.g., such as described above regarding FIGS. 1-6, 11-12, etc.) for later processing or can provide it to other components, or a processor 906, via memory 910 over a suitable communications bus or otherwise, or to the output component 912. It can be understood that, while system 700 and user interface component 702 are shown external to the input component 902, storage component 904, processor 906, memory 910, and output component 912, functionality of system 700 and/or user interface component 702 can be provided, at least in part, by one or more of the component(s) of systems or apparatuses 900 (e.g., input component 902, storage component 904, processor 906, memory 910, and/or output component 912). That is input component 704 and output component 706, and/or functionality thereof, can be provided, at least in part, by input component 902 and output component 912, respectively, whereas user interface component 702 and/or authentication component 708, and/or functionality thereof, can be provided, at least in part, by computer executable instructions stored in memory 910 and executed on processor 906.

Processor 906 can be a processor dedicated to analyzing information received by input component 902 and/or generating information for transmission by an output component 912. Processor 906 can be a processor that controls one or more portion(s) of systems or apparatuses 900, systems 700 or portions thereof, and/or a processor that can analyze information received by input component 902, can generate information for transmission by output component 912, and can perform various algorithms or operations associated with presenting images to a user, receiving input, storing or transmitting information, verifying input, sending and receiving information according to various protocols, performing analytical routines, or as further described herein, for example, regarding FIGS. 11-12. In addition, systems or apparatuses 900 can include further various components, as described above, for example, regarding FIGS. 7-8, that can perform various techniques as described herein, in addition to the various other functions required by other components as described above.

As a non-limiting example of FIG. 9 as a system or apparatus 900, while system 700 and user interface component 702 are shown external to the processor 906 and memory 910, it is to be appreciated that system 700 and/or portions thereof can include code or instructions stored in storage component 904 and subsequently retained in memory 910 for execution by processor 906. In addition, system 700, and/or system or apparatus 900, can utilize artificial intelligence based methods (e.g., components employing speech and language recognition and processing algorithms, statistical and inferential algorithms, randomization techniques, etc.) in connection with performing inference and/or probabilistic determinations and/or statistical-based determinations (e.g., randomizations based on random or pseudo-random number generations, etc.) in connection with techniques described herein.

Systems or apparatuses 900 can additionally comprise memory 910 that is operatively coupled to processor 906 and that stores information such as described above, user authentication credentials, images, labels, and the like, wherein such information can be employed in connection with implementing the user authentication credential generations and user authentication systems, methods, and so on as described herein. Memory 910 can additionally store protocols associated with generating lookup tables, etc., such that systems or apparatuses 900 can employ stored protocols and/or algorithms further to the performance of various algorithms and/or portions thereof as described herein.

It will be appreciated that storage component 904 and memory 906, or any combination thereof as described herein, can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), and direct Rambus® RAM (DRRAM). The memory 910 is intended to comprise, without being limited to, these and any other suitable types of memory, including processor registers and the like. In addition, by way of illustration and not limitation, storage component 904 can include conventional storage media as in known in the art (e.g., hard disk drives, etc.).

Accordingly, in further non-limiting implementations, exemplary systems or apparatuses 900 (e.g., such as a device that can facilitate generating a user authentication credential, etc.) can comprise means for displaying one or more set(s) of images to a user (e.g., user 104, etc.) via a user interface of a device (e.g., device 106, computer system 102, etc.), as further described herein, for example, regarding FIGS. 11-12. For instance, regarding systems or apparatuses 900, as further described herein, the means for displaying can include means for displaying one or more set(s) of images, one image per set at a time, based on a random or pseudo-random determination of images to be displayed, as described above. In addition, the means for displaying can include means for generating the one or more set(s) of images from a second set of images based on random or pseudo-random selection of images to be displayed in the one or more set(s) of images, where the one or more set(s) of images can comprise a subset of images from the second set of images, as further described herein, for example, regarding FIGS. 11-12. In further non-limiting implementations of systems or apparatuses 900, the means for displaying can include means for displaying a second plurality of sets of images (e.g., based on a rejection (e.g., by a user, by user 104, etc.) of the one or more set(s) of images, a requirement to reset the user authentication credential, or passage of a predetermined period of time, etc.). In other non-limiting example, the means for displaying can include means for displaying the one or more set(s) of images in a row of images to facilitate scrolling one or more image(s) of the row of images, for example, and to allow viewing alternate images in one or more of the one or more set(s) of images, as further described herein, for instance, regarding FIGS. 11-12. As a further example, the means for displaying can include means for scrolling one or more image(s) of the row of images (e.g., by manual scrolling by a user (e.g., user 104, etc.), automated scrolling by the user interface, etc.).

In further non-limiting embodiments of systems or apparatuses 900, the means for displaying can include means for displaying the one or more set(s) of images, where one or more set(s) of images can be associated with one of the disparate parts of speech, as further described herein, for example, regarding FIGS. 11-12. In addition, the means for displaying can include means for displaying one or more set(s) of images based on a determination of which of the disparate parts of speech associated with the one or more set(s) of images is to be displayed (e.g., via a language processing algorithm, etc.). For still other non-limiting implementations of systems or apparatuses 900, the means for displaying can include means for displaying the one or more set(s) of images, where one or more image(s) of the one or more set(s) of images can comprise one or more sub-image(s), and where one or more of the sub-image(s) can be associated with one of the disparate parts of speech, as further described herein, for example, regarding FIGS. 11-12. Additionally, the means for displaying can further include means for displaying respective labels associated with the one or more set(s) of images, where the respective labels can be associated with a subset of the disparate parts of speech, as described herein. Thus, the means for displaying can also include means for displaying one or more further set(s) of images associated with an additional disparate part of speech comprising an adjective, a pronoun, a complement, a direct object, an indirect object, a preposition, or an object of the preposition and so on, etc.

Furthermore, systems or apparatuses 900 can comprise a means for accepting input that indicates a selection of a subset of images of the one or more set(s) of images, where the selection can correspond to a grammatical structure, for example, as described herein regarding FIGS. 4-8, 11-12, etc. In further non-limiting implementations of systems or apparatuses 900, the means for accepting input can include means for accepting a character string comprising the grammatical structure or portions thereof including, in a particular non-limiting aspect, at least a subject, a verb, and an adverb. In addition, further non-limiting embodiments of systems or apparatuses 900 can comprise a means for accepting input can include means for accepting a combination of an image of the selection and a subset of the grammatical structure, as further described herein, for example, regarding FIGS. 11-12. In still further non-limiting implementations of systems or apparatuses 900, the means for accepting input can include means for accepting the input based on a second number (e.g., one or more) of set(s) of images. Additionally, in other non-limiting implementations, the means for accepting input can include means for accepting input comprising the grammatical structure including an adjective, a pronoun, a complement, a direct object, an indirect object, a preposition, or an object of the preposition, and so on, etc.

In addition, exemplary systems or apparatuses 900 can further comprise means for storing or transmitting the selection or the grammatical structure as the user authentication credential, for example, as described above regarding FIGS. 1-7. In further non-limiting implementations of systems or apparatuses 900, the means for storing or transmitting can include means for storing or transmitting the user authentication credential based on a second number (e.g., one or more) of set(s) of images. For instance, in particular non-limiting implementations, the means for storing or transmitting can include means for storing or transmitting the user authentication credential to facilitate permitting access to a restricted access system, permitting access to a restricted access device, comparing the user authentication credential to a stored user authentication credential, resetting the stored user authentication credential to a reset user authentication credential, determining that a user (e.g., user 104, etc.) can be authorized to access a second user authentication credential, and/or granting access to restricted access information, and so on, etc.

It can be understood that in various non-limiting implementations of FIG. 9 as an apparatus 900 (e.g., such as a device that can facilitate generating a user authentication credential, computer system 102, device 106, etc.), various aspects of the disclosed subject matter as described herein can be performed by a device 106 such as a mobile device. That is, various non-limiting aspects of the disclosed subject matter can be performed by a device 106 having portions of FIG. 9 (e.g., input component 902, storage component 904, processor 906, memory 910, output component 912, system 700, user interface component 702, and so on, etc.).

Thus, in still other non-limiting implementations, exemplary systems or apparatuses 900, can also comprise device 106, such as a mobile device, as described above regarding FIGS. 1-8, etc., for instance, and as further describe below regarding FIG. 11-16. As a non-limiting example, device 106 (e.g., such as a device that can facilitate generating a user authentication credential, etc.) can comprise the means for displaying, the means for accepting, the means for storing or transmitting, and so on, etc., for instance, as further described herein.

In still further non-limiting implementations, exemplary systems or apparatuses 900 (e.g., such as a device that can facilitate user authentication, etc.) can comprise means for displaying one or more set(s) of images to a user via a user interface of a device (e.g., device 106, computer system 102, etc.), as further described herein, for example, regarding FIGS. 11-12. For instance, regarding systems or apparatuses 900, as further described herein, the means for displaying can include means for displaying the one or more set(s) of images in a row of images to facilitate manual scrolling of one or more image(s) of the row of images, for example, and to allow display of alternate images in one or more set(s) of images.

In addition, exemplary systems or apparatuses 900 can also comprise means for determining that the input does not match the stored user authentication credential, means for denying user access based on a determination that the input that does not match after a predetermined number of attempts, and so on. In further non-limiting implementations, systems or apparatuses 900 can comprise means for displaying a second plurality of sets of images in response the determination (e.g., that the input that does not match after a predetermined number of attempts, etc.). In other non-limiting examples, the means for displaying can include means for displaying the one or more set(s) of images in a row of images, as further described herein, for example, regarding FIGS. 11-12. For instance, the means for displaying can include means for scrolling one or more image(s) of the row of images.

In further non-limiting embodiments of systems or apparatuses 900, the means for displaying can include means for displaying the one or more set(s) of images, where one or more set(s) of images can be associated with one of the disparate parts of speech, as further described herein. In addition, the means for displaying can include means for displaying the one or more set(s) of images, where one or more image(s) of the one or more set(s) of images comprises one or more sub-image(s), and where one or more of the sub-image(s) can be associated with one of the disparate parts of speech, as further described herein, for example, regarding FIGS. 11-12. For still other non-limiting implementations of systems or apparatuses 900, the means for displaying include means for displaying respective labels associated with the one or more set(s) of images, where the respective labels can be associated with a subset of the disparate parts of speech. Additionally, the means for displaying can further include means for displaying one or more further set(s) of images associated with an additional disparate part of speech comprising an adjective, a pronoun, a complement, a direct object, an indirect object, a preposition, or an object of the preposition, and so on, etc.

Furthermore, systems or apparatuses 900 can comprise a means for accepting input comprising a selection of a subset of images of the one or more set(s) of images or a grammatical structure, where the selection can be associated with a user authentication credential, for example, as described above regarding FIGS. 4-8, 11-12, etc. In other non-limiting implementations of systems or apparatuses 900, the means for accepting input can include means for accepting a character string comprising the grammatical structure including at least a subject, a verb, and an adverb, as further described herein, for example, regarding FIGS. 11-12. In addition, further non-limiting embodiments of systems or apparatuses 900 can comprise a means for accepting input configured to accept a combination of an image of the selection and a subset of the grammatical structure, as described above. In still further non-limiting implementations of systems or apparatuses 900, the means for accepting input can include means for accepting the input based on a second number (e.g., one or more) of set(s) of images. Moreover, in other non-limiting implementations, the means for accepting input can include means for accepting input comprising the grammatical structure including an adjective, a pronoun, a complement, a direct object, an indirect object, a preposition, or an object of the preposition, and so on.

In addition, exemplary systems or apparatuses 900 can further comprise means for verifying the input matches a stored user authentication credential., for example, as described above regarding FIGS. 1-7. For instance, in particular non-limiting implementations, the means for verifying can include means for verifying the input to facilitate permitting access to a restricted access system, permitting access to a restricted access device, resetting the stored user authentication credential to a reset user authentication credential, determining that a user (e.g., user 104, etc.) can be authorized to access a second user authentication credential, granting access to restricted access information, and so on, etc. In further non-limiting implementations, systems or apparatuses 900 can further comprise one or more of means for verifying the input matches the stored user authentication credential, means for storing the input as the user authentication credential, and/or means for transmitting the input as the user authentication credential, as described herein.

Thus, it can be further understood that in various non-limiting implementations of FIG. 9 as an apparatus 900 (e.g., such as a device that can facilitate user authentication, computer system 102, device 106, etc.), various aspects of the disclosed subject matter as described herein can be performed by a device 106 such as a mobile device. That is, various non-limiting aspects of the disclosed subject matter can be performed by a device 106 having portions of FIG. 9 (e.g., input component 902, storage component 904, processor 906, memory 910, output component 912, system 700, user interface component 702, and so on, etc.).

Thus, in still other non-limiting implementations, exemplary systems or apparatuses 900, can also comprise device 106, such as a mobile device, as described above regarding FIGS. 1-8, etc., for instance, and as further describe below regarding FIG. 11-16. As a non-limiting example, device 106 can comprise the means for displaying, the means for accepting, the means verifying, the means for storing or transmitting, and so on, or portions thereof, etc., for instance, as further described herein.

### Exemplary User Interface

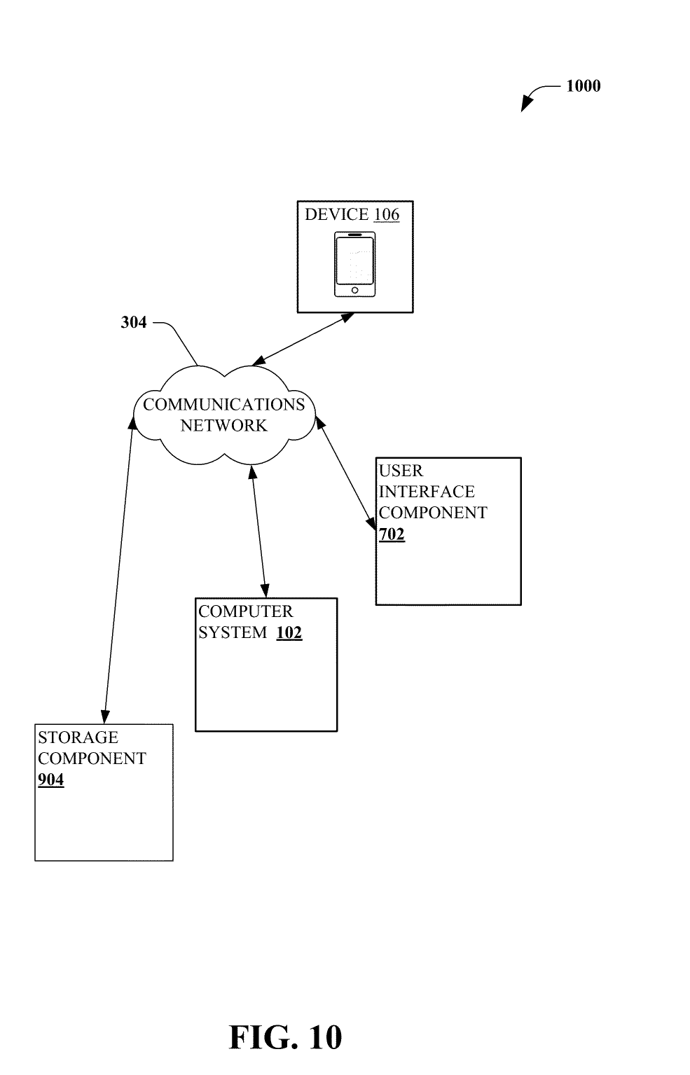

FIG. 10 depicts exemplary non-limiting systems and apparatuses 1000 suitable for performing various techniques of the disclosed subject matter. Thus, in still other non-limiting implementations, exemplary systems or apparatuses 1000 can include user interface component 702, device 106, such as a mobile device, computer system 102, and/or storage component 904 (e.g., of apparatus 900), etc., or a subset or portions thereof, as described above regarding FIG. 1-9, etc., for instance, and as further describe below regarding FIG. 11-16. As further described above, various functionality as described herein, and/or portions thereof can be provided or facilitated by one or more of device 106, computer system 102, user interface component 702, storage component 904, and/or other computer executable agents or intermediaries of device 106 and/or computer system 102.

For instance, in a non-limiting example of a device 106 that can facilitate user authentication and/or user authentication credential generation techniques as described herein, FIG. 11 depicts an exemplary user interface component (e.g., via user interface component 702, etc.) of a computer system 1100 (e.g., device 106, computer system 102, system 700, device 800, apparatus 900, etc.) in communication with communications network 304 (not shown), as previously described. Thus, it can be seen in FIG. 11 that user interface component 702, when executed by or on behalf of device 106 (or when functionality of user interface component 702 is provided in part by device 106, etc.), can facilitate various aspects as described herein (e.g., storage of user authentication credentials, storage of sets of images to be displayed or presented, accepting or receiving user input, comparisons of and/or verifications of user input with stored user authentication credentials, transmission of associated data, and so on, etc.). In addition, as further described above, computer system 1100 can comprise various functionality as described above, for example, regarding systems 700 of FIG. 7. Thus, computer system 1100 can further comprise or be associated with an input component 704, an output component 706, and/or an authentication component 708, as well as other ancillary and/or supporting components, and/or portions thereof, as described herein.

As a non-limiting example, returning to the analogy of the slot machine description of a “drum” with digits and image cells as described above, the exemplary user interface can comprise a drum 1102 with one or more digit(s) (e.g., digit 1 (1104), digit 2 (1106), digit N (1108), etc.) and one or more corresponding rotating image(s) in image cells (e.g., image cell 1 (1110), image cell 2 (1112), image cell N (1114), etc.) to facilitate user authentication and/or user authentication credential generation techniques as described herein.

According to further non-limiting implementations, user interface 702 according to non-limiting aspects of the disclosed subject matter can also provide respective labels (e.g., labels 1 (1116), labels 2 (1118), labels N (1120), etc.) to facilitate further aspects of user authentication and/or user authentication credential generation techniques as described herein. In further non-limiting aspects, a user interface according to the disclosed subject matter can also comprise one or more user authentication credential display/entry form(s) 1122, that can, inter alia, facilitate display of a proposed user authentication credential, display a tentative selection or portions thereof based on the rotation of the images in the image cells, entry of character strings, copy and/or paste of one or more character(s) or character string(s) or other data such as a subset of the images, and so on.

Furthermore, user interface 702 according to other non-limiting aspects of the disclosed subject matter can comprise various controls (e.g., control 1 (1124), control M (1126), and so on, etc.) that can, inter alia, facilitate a user (e.g., user 104, etc.) accepting and/or rejecting a proposed user authentication credential, receiving input regarding a user authentication credential, selecting one or more image(s), submitting a user authentication credential, and/or transmitting a user authentication credential, scrolling the one or more of the image(s) of the images cells, and/or generating a proposed user authentication credential via an automated or semi-automated algorithm based on a random, pseudo-random, or language processing algorithm, and so on, etc. It can be understood that the above descriptions are merely exemplary and do not limit the disclosed subject matter or encompass the entire range of possible options for user authentication and/or user authentication credential generation according to the techniques as described herein. Further examples and descriptions are intended to further illustrate non-limiting aspects regarding displaying or presenting a series or plurality of sets of images, receiving or accepting input that indicates a selection, and so on according to various non-limiting embodiments.

For example, as can be seen in the functional block diagram of FIG. 12, drum 1102 is depicted with one or more digit(s) (e.g., digit 1 (1104), digit 2 (1106), digit N (1108), etc.) and one or more corresponding rotating image(s) of the image cells (e.g., image cell 1 (1110), image cell 2 (1112), image cell N (1114), etc.) as well as respective labels (e.g., labels 1 (1116), labels 2 (1118), labels N (1120), etc.) to facilitate user authentication and/or user authentication credential generation techniques as described herein. In addition, in a non-limiting example, FIG. 12 depicts two parallel 6×3 matrices of images and respective labels corresponding to the images in image cells 1202, 1206, and 1210 with corresponding labels 1204, 1208, 1212, respectively. Thus, the images of image cell 1202 can comprise a set of images, whereas the images of image cells 1206 and 1210 can comprise two additional sets of images. As can be understood, in the present context, such images and/or labels can be stored locally (e.g., on device 106, etc.), or remotely (e.g., on computer system 102, on intermediary or agent devices or systems, etc.), and can be transmitted for presentation or display on device 106, for example, as further described above.

Note that the sets of images in image cells 1202, 1206, and 1210 need not be mutually exclusive sets, and/or the sets of images can be comprised from a subset of a larger set of images that can be employed to facilitate the techniques described herein. Thus, the exemplary user interface as depicted in FIGS. 11-12 can facilitate displaying or presenting a series or a plurality of sets of images (e.g., in image cells 1202, 206, and 1210, etc.) to a user via a user interface of a computer (e.g., device 106, etc.). Note further that, as described herein, the rotating images of the image cells (e.g., image cells 1202, 206, and 1210, etc.) can be presented or displayed based on a random or pseudo-random determination of images to be presented, based on a language processing algorithm, and/or by manually or automatically scrolling the images in the image cells, and so on, etc. Thus, in the context of user authentication credential generation, images of the sets of images can be presented or displayed in the image cells (e.g., image cell 1 (1110), image cell 2 (1112), image cell N (1114), etc.) of drum 1102, based on a random or pseudo-random selection, or otherwise, and respective labels (e.g., labels 1 (1116), labels 2 (1118), labels N (1120), etc.) can be presented or displayed. Accordingly the images and/or the respective labels can facilitate user authentication credential generation capable of memorization by virtue of being or instantiating a funny or peculiar sentence or turn of phrase, as further described above.

In addition, in further non-limiting implementations, an exemplary user interface 702, according to aspects of the disclosed subject matter can facilitate presenting or displaying images comprising more than one sub-image. That is, one or more image(s) of the image cells can comprise a number of images or sub-images to comprise a scene, as further described above. For instance, image 1214 of image cell 1202 comprises an image of a farm, which further comprises sub-images of a barn, a silo, a tree, a road, a yard, and so on, etc. Accordingly, a set of respective labels 1216 of labels 1204 associated with image 1214 can comprise respective labels, such as “farm,” “silo,” “barn,” or other suitable labels, and so on, etc., as well as plural forms or language, dialect, or grammar specific forms, which can be specific to particular non-limiting implementations. However, FIG. 12 also depicts instances of an image 1218 only comprising one image with one respective label 1220 “tractor.” Thus, it can be seen that, in the contexts of user authentication credential generation and/or user authentication, various aspects of the disclosed subject matter can offer options with great flexibility for memorization and security, based on a user's interpretation of images displayed or presented, based on respective labels available, employing disparate parts of speech, and so on.

Note further that, in the particular non-limiting example depicted in FIG. 12, the pair of respective labels 1204 and the corresponding image cell 1202 can be associated with a disparate part of speech (e.g., a noun or a subject in this instance). Likewise, the pairs of respective labels 1208 and corresponding image cell 1206 and respective labels 1212 and corresponding image cell 1210 are each associated with two additional disparate parts of speech (e.g., verb for respective labels 1208 and image cell 1206 and adverb for respective labels 1212 and image cell 1210). Note further that, as described herein, further images of additional image cells and/or respective labels can be associated with additional disparate parts of speech, including but not limited to an adjective, a pronoun, a complement, a direct object, an indirect object, a preposition, or an object of the preposition, and so on, etc. Further note that, depending on the one or more respective label(s) selected for a particular image of the sets of images, the particular image can be associated with different ones of the disparate parts of speech. For instance, considering the image 1214 of the scene of a farm, respective labels can comprise labels associated with noun or subject parts of speech, such as “farm,” “silo,” “barn,” or other suitable labels, and so on, etc., as well as plural forms or language, dialect, or grammar specific forms which can be specific to particular non-limiting implementations. In another non-limiting instance of one or more respective label(s) selected for a particular image (e.g., image 1214) of the sets of images, respective labels can comprise labels associated with a verb part of speech, such as “grow,” “relax,” “farm,” or other suitable labels, and so on, etc., as well as language or grammar specific forms, which can be specific to particular non-limiting implementations (e.g., tenses, participles, etc.).

Accordingly, it can be seen from the description of exemplary user interface, according to the disclosed subject matter regarding FIGS. 11-12, how an exemplary user interface can facilitate accepting or receiving input that indicates a selection of a subset of images of the plurality of sets of images, where the selection can correspond to a grammatical structure. For instance, if a user is presented with the image cells as depicted in FIG. 12 where the rotation of images in the image cells displays or presents the selection indicated by selection 1222, possible grammatical structures corresponding to such a selection can comprise a subject, a verb, and an adverb with possible combinations of subject, verb, and adverb available from either respective labels or from user generated variations of the subject, verb, and adverb. For instance, when employing the one or more respective label(s) to arrive at a grammatical structure, such possible grammatical structures can include peculiar or humorous turns of phrase, such as: “bunnies spend begrudgingly;” “holidays save early;” “egg costs early;” “Easter spends early;” and so on, etc. Thus, the exemplary user interface, according to non-limiting aspects, can facilitate receiving input that indicates a selection of the subset of images (e.g., selection 1222) of the plurality of sets of images (e.g., in image cells 1202, 206, and 1210, etc.), where the selection can correspond to a grammatical structure as described above. As further described herein, the exemplary user interface according to the disclosed subject matter regarding FIGS. 11-12 can facilitate storing and/or transmitting the selection or the grammatical structure as the user authentication credential, according to further non-limiting aspects.

The various functionalities or portions thereof can be understood to facilitate respective functions and/or features as indicated and as further described above, for example, regarding FIGS. 1-9, etc.

### Exemplary Mobile Device

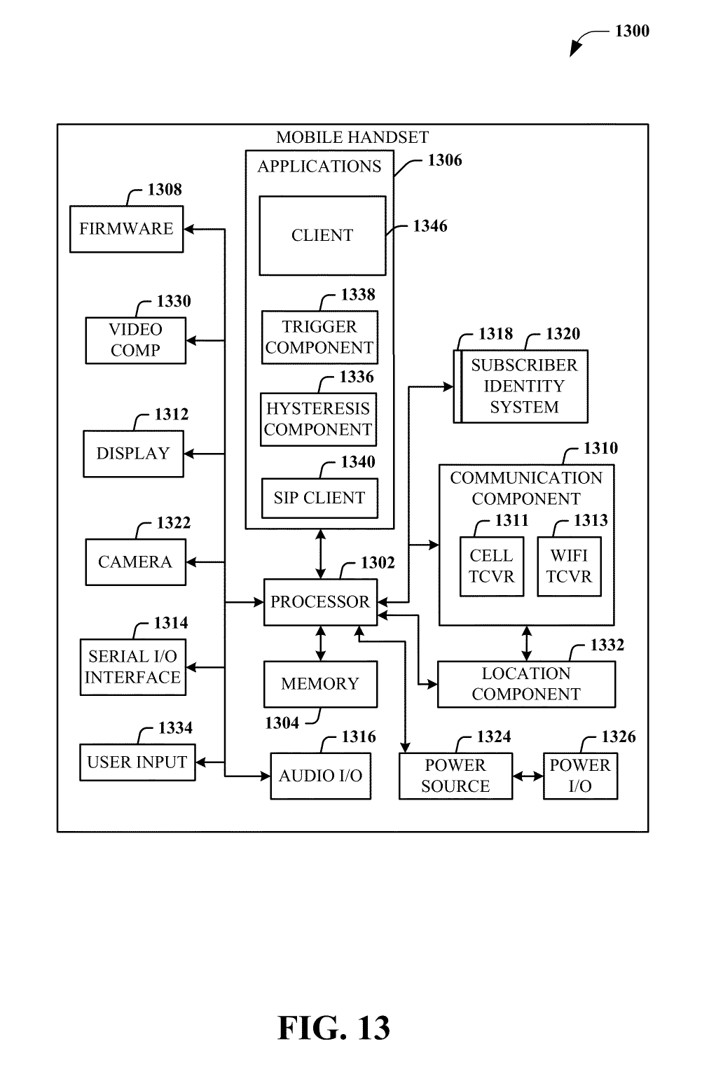

FIG. 13 depicts a schematic diagram of an exemplary mobile device 1300 (e.g., a mobile handset) that can facilitate various non-limiting aspects of the disclosed subject matter in accordance with the embodiments described herein. Although mobile handset 1300 is illustrated herein, it will be understood that other devices can be a mobile device, as described above regarding FIG. 3, for instance, and that the mobile handset 1300 is merely illustrated to provide context for the embodiments of the subject matter described herein. The following discussion is intended to provide a brief, general description of an example of a suitable environment 1300 in which the various embodiments can be implemented. While the description includes a general context of computer-executable instructions embodied on a computer readable storage medium, those skilled in the art will recognize that the subject matter also can be implemented in combination with other program modules and/or as a combination of hardware and software.

Generally, applications (e.g., program modules) can include routines, programs, components, data structures, etc., that perform or facilitate performing particular tasks and/or implement or facilitate implementing particular abstract data types. Moreover, those skilled in the art will appreciate that the techniques described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated device(s).

A computing device can typically include a variety of computer-readable media, as further described herein, for example, regarding FIGS. 8-9. Computer readable media can comprise any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media, as distinguished from computer-readable media, and/or computer-readable storage media, typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable media or computer-readable storage media.

The handset 1300 can include a processor 1302 for controlling and processing all onboard operations and functions. A memory 1304 can interface to the processor 1302 for storage of data and one or more application(s) 1306. Other applications can support operation of communications and/or communications protocols. The applications 1306 can be stored in the memory 1304 and/or in a firmware 1308, and executed by the processor 1302 from either or both the memory 1304 or/and the firmware 1308. The firmware 1308 can also store startup code for execution in initializing the handset 1300. A communications component 1310 can interface to the processor 1302 to facilitate wired/wireless communication with external systems, e.g., cellular networks, VoIP networks, and so on. Here, the communications component 1310 can also include a suitable cellular transceiver 1311 (e.g., a GSM transceiver) and/or an unlicensed transceiver 1313 (e.g., Wireless Fidelity (WiFi™), Worldwide Interoperability for Microwave Access (WiMax®)) for corresponding signal communications. The handset 1300 can be a device such as a cellular telephone, a PDA with mobile communications capabilities, and messaging-centric devices. The communications component 1310 can also facilitate communications reception from terrestrial radio networks (e.g., broadcast), digital satellite radio networks, and Internet-based radio services networks.

The handset 1300 can include a display 1312 for displaying text, images, video, telephony functions (e.g., a Caller ID function), setup functions, and for user input. For example, the display 1312 can also be referred to as a “screen” that can accommodate the presentation of multimedia content (e.g., images, metadata, messages, wallpaper, graphics, etc.). The display 1312 can also display videos and can facilitate the generation, editing and sharing of video quotes. A serial I/O interface 1314 can be provided in communication with the processor 1302 to facilitate wired and/or wireless serial communications (e.g., Universal Serial Bus (USB), and/or Institute of Electrical and Electronics Engineers (IEEE) 1394) through a hardwire connection, and other serial input devices (e.g., a keyboard, keypad, and mouse). This can support updating and troubleshooting the handset 1300, for example. Audio capabilities can be provided with an audio I/O component 1316, which can include a speaker for the output of audio signals related to, for example, indication that the user pressed the proper key or key combination to initiate the user feedback signal. The audio I/O component 1316 can also facilitate the input of audio signals through a microphone to record data and/or telephony voice data, and for inputting voice signals for telephone conversations.

The handset 1300 can include a slot interface 1318 for accommodating a SIC (Subscriber Identity Component) in the form factor of a card Subscriber Identity Module (SIM) or universal SIM 1320, and interfacing the SIM card 1320 with the processor 1302. However, it is to be appreciated that the SIM card 1320 can be manufactured into the handset 1300, and updated by downloading data and software.

The handset 1300 can process Internet Protocol (IP) data traffic through the communication component 1310 to accommodate IP traffic from an IP network such as, for example, the Internet, a corporate intranet, a home network, a person area network, etc., through an ISP or broadband cable provider. Thus, VoIP traffic can be utilized by the handset 1300 and IP-based multimedia content can be received in either an encoded or a decoded format.

A video processing component 1322 (e.g., a camera) can be provided for decoding encoded multimedia content. The video processing component 1322 can aid in facilitating the generation and/or sharing of video. The handset 1300 also includes a power source 1324 in the form of batteries and/or an alternating current (AC) power subsystem, which power source 1324 can interface to an external power system or charging equipment (not shown) by a power input/output (I/O) component 1326.

The handset 1300 can also include a video component 1330 for processing video content received and, for recording and transmitting video content. For example, the video component 1330 can facilitate the generation, editing and sharing of video. A location-tracking component 1332 can facilitate geographically locating the handset 1300. A user input component 1334 can facilitate the user inputting data and/or making selections as previously described. The user input component 1334 can also facilitate generation of a user authentication credential and/or user authentication, as well as composing messages and other user input tasks as required by the context. The user input component 1334 can include such conventional input device technologies such as a keypad, keyboard, mouse, stylus pen, and/or touch screen, for example.

Referring again to the applications 1306, a hysteresis component 1336 can facilitate the analysis and processing of hysteresis data, which is utilized to determine when to associate with an access point. A software trigger component 1338 can be provided that can facilitate triggering of the hysteresis component 1338 when a WiFi™ transceiver 1313 detects the beacon of the access point. A SIP client 1340 can enable the handset 1300 to support SIP protocols and register the subscriber with the SIP registrar server. The applications 1306 can also include a communications application or client 1346 that, among other possibilities, can be user authentication and/or other user interface component functionality as described above.

The handset 1300, as indicated above related to the communications component 1310, can include an indoor network radio transceiver 1313 (e.g., WiFi transceiver). This function supports the indoor radio link, such as IEEE 802.11, for the dual-mode Global System for Mobile Communications (GSM) handset 1300. The handset 1300 can accommodate at least satellite radio services through a handset that can combine wireless voice and digital radio chipsets into a single handheld device.

It can be understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

### Exemplary Computer Networks and Environments

One of ordinary skill in the art can appreciate that the disclosed subject matter can be implemented in connection with any computer or other client or server device, which can be deployed as part of a communications system, a computer network, or in a distributed computing environment, connected to any kind of data store. In this regard, the disclosed subject matter pertains to any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by exchange between computing devices and systems. These resources and services can include the exchange of information, cache storage, and disk storage for objects, such as files. Distributed computing takes advantage of network connectivity, allowing clients to leverage their collective power to benefit the entire enterprise. In this regard, a variety of devices can have applications, objects, or resources that may implicate the communication systems using the techniques, systems, and methods of the disclosed subject matter.

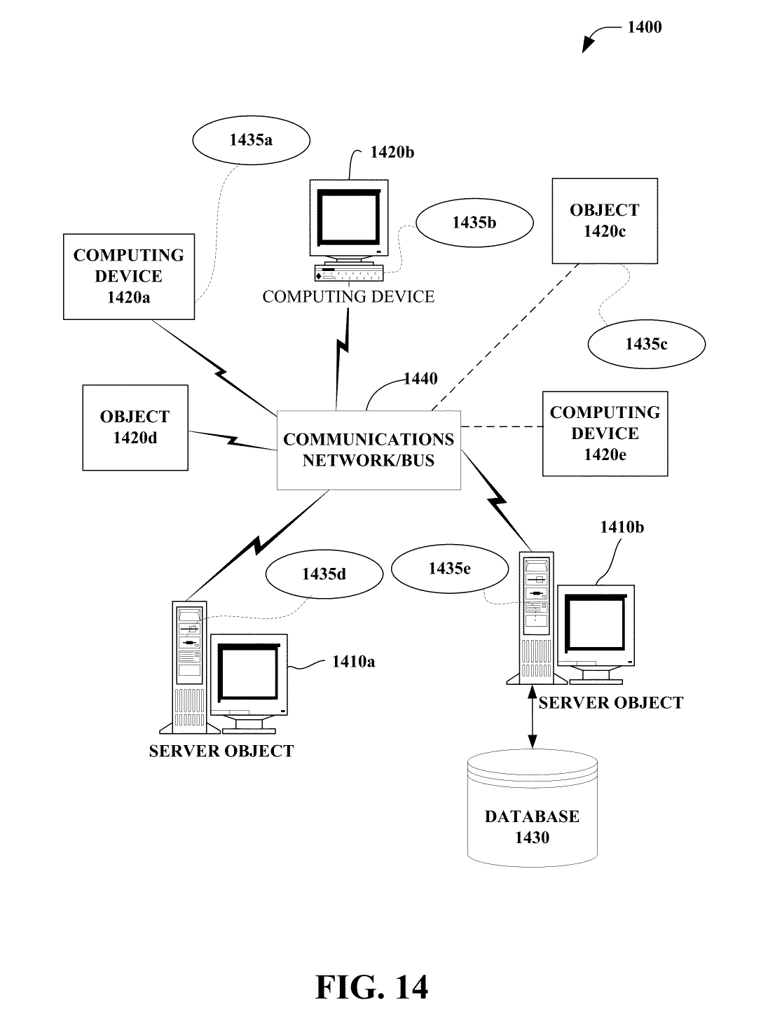

FIG. 14 provides a schematic diagram of an exemplary networked or distributed computing environment. The distributed computing environment comprises computing objects 1410a, 1410b, etc. and computing objects or devices 1420a, 1420b, 1420c, 1420d, 1420e, etc. These objects can comprise programs, methods, data stores, programmable logic, etc. The objects can also comprise portions of the same or different devices such as PDAs, audio/video devices, MP3 players, personal computers, etc. Each object can communicate with another object by way of the communications network 1440. This network can itself comprise other computing objects and computing devices that provide services to the system of FIG. 14, and can itself represent multiple interconnected networks. In accordance with an aspect of the disclosed subject matter, each object 1410a, 1410b, etc. or 1420a, 1420b, 1420c, 1420d, 1420e, etc. can contain an application that can make use of an API, or other object, software, firmware and/or hardware, suitable for use with the techniques in accordance with the disclosed subject matter.

It can also be appreciated that an object, such as 1420c, can be hosted on another computing device 1410a, 1410b, etc. or 1420a, 1420b, 1420c, 1420d, 1420e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There is a variety of systems, components, and network configurations that support distributed computing environments. For example, computing systems can be connected together by wired or wireless systems, by local networks or widely distributed networks. Currently, many of the networks are coupled to the Internet, which can provide an infrastructure for widely distributed computing and can encompass many different networks. Any of the infrastructures can be used for communicating information used in systems employing the techniques, systems, and methods according to the disclosed subject matter.

The Internet commonly refers to the collection of networks and gateways that utilize the Transmission Control Protocol/Internet Protocol (TCP/IP) suite of protocols, which are well known in the art of computer networking. The Internet can be described as a system of geographically distributed remote computer networks interconnected by computers executing networking protocols that allow users to interact and share information over network(s). Because of such widespread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client can be a process, e.g., roughly a set of instructions or tasks, that requests a service provided by another program. The client process can utilize the requested service without having to “know” any working details about the other program or the service itself. In client/server architecture, particularly a networked system, a client is usually a computer that accesses shared network resources provided by another computer, e.g., a server. In the illustration of FIG. 14, as an example, computers 1420a, 1420b, 1420c, 1420d, 1420e, etc. can be thought of as clients and computers 1410a, 1410b, etc. can be thought of as servers where servers 1410a, 1410b, etc. maintain the data that is then replicated to client computers 1420a, 1420b, 1420c, 1420d, 1420e, etc., although any computer can be considered a client, a server, or both, depending on the circumstances. Any of these computing devices can be processing data or requesting services or tasks that may use or implicate the techniques, systems, and methods in accordance with the disclosed subject matter.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to communication (wired or wirelessly) using the techniques, systems, and methods of the disclosed subject matter may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) can be coupled to one another via TCP/IP connection(s) for high-capacity communication.

Thus, FIG. 14 illustrates an exemplary networked or distributed environment, with server(s) in communication with client computer (s) via a network/bus, in which the disclosed subject matter may be employed. In more detail, a number of servers 1410a, 1410b, etc. are interconnected via a communications network/bus 1440, which can be a LAN, WAN, intranet, GSM network, the Internet, etc., with a number of client or remote computing devices 1420a, 1420b, 1420c, 1420d, 1420e, etc., such as a portable computer, handheld computer, thin client, networked appliance, or other device, such as a VCR, TV, oven, light, heater and the like in accordance with the disclosed subject matter. It is thus contemplated that the disclosed subject matter can apply to any computing device in connection with which it is desirable to communicate data over a network.

In a network environment in which the communications network/bus 1440 is the Internet, for example, the servers 1410a, 1410b, etc. can be Web servers with which the clients 1420a, 1420b, 1420c, 1420d, 1420e, etc. communicate via any of a number of known protocols such as HTTP. Servers 1410a, 1410b, etc. can also serve as clients 1420a, 1420b, 1420c, 1420d, 1420e, etc., as may be characteristic of a distributed computing environment.

As mentioned, communications to or from the systems incorporating the techniques, systems, and methods of the disclosed subject matter can ultimately pass through various media, either wired or wireless, or a combination, where appropriate. Client devices 1420a, 1420b, 1420c, 1420d, 1420e, etc. may or may not communicate via communications network/bus 14, and may have independent communications associated therewith. For example, in the case of a TV or VCR, there may or may not be a networked aspect to the control thereof. Each client computer 1420a, 1420b, 1420c, 1420d, 1420e, etc. and server computer 1410a, 1410b, etc. can be equipped with various application program modules or objects 1435a, 1435b, 1435c, etc. and with connections or access to various types of storage elements or objects, across which files or data streams may be stored or to which portion(s) of files or data streams may be downloaded, transmitted or migrated. Any one or more of computers 1410a, 1410b, 1420a, 1420b, 1420c, 1420d, 1420e, etc. can be responsible for the maintenance and updating of a database 1430 or other storage element, such as a database or memory 1430 for storing data processed or saved based on, or the subject of, communications made according to the disclosed subject matter. Thus, the disclosed subject matter can be utilized in a computer network environment having client computers 1420a, 1420b, 1420c, 1420d, 1420e, etc. that can access and interact with a computer network/bus 1440 and server computers 1410a, 1410b, etc. that can interact with client computers 1420a, 1420b, 1420c, 1420d, 1420e, etc. and other like devices, and databases 1430.

### Exemplary Computing Device

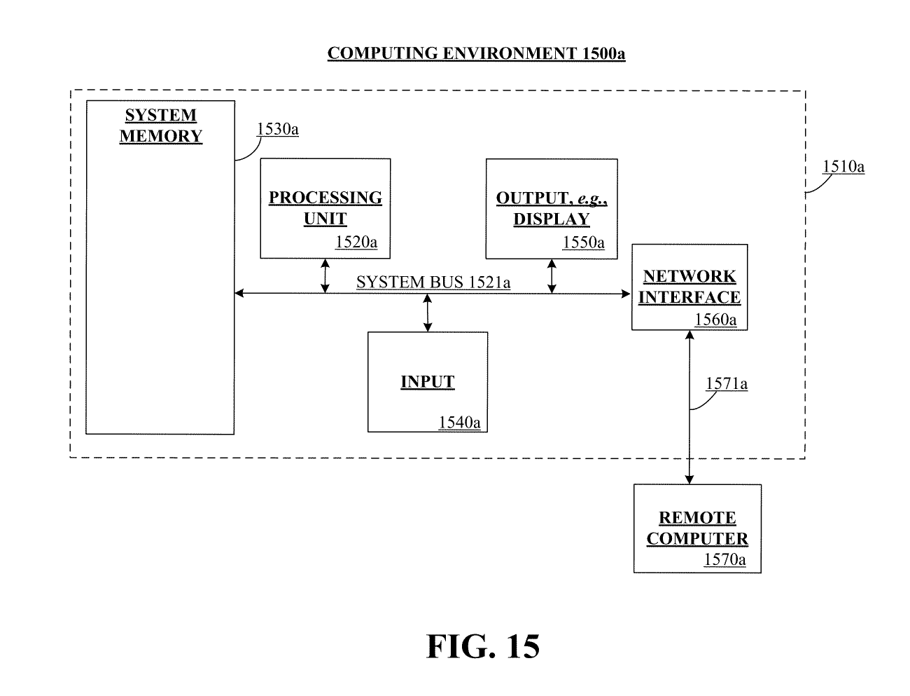

As mentioned, the disclosed subject matter applies to any device wherein it may be desirable to communicate data, e.g., to or from a mobile device. It should be understood, therefore, that handheld, portable and other computing devices and computing objects of all kinds are contemplated for use in connection with the disclosed subject matter, e.g., anywhere that a device can communicate data or otherwise receive, process or store data. Accordingly, the below general purpose remote computer described below in FIG. 15 is but one example, and the disclosed subject matter can be implemented with any client having network/bus interoperability and interaction. Thus, the disclosed subject matter can be implemented in an environment of networked hosted services in which very little or minimal client resources are implicated, e.g., a networked environment in which the client device serves merely as an interface to the network/bus, such as an object placed in an appliance.

Although not required, some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules or components, being executed by one or more computer(s), such as client workstations, servers or other devices. Those skilled in the art will appreciate that the disclosed subject matter may be practiced with other computer system configurations and protocols.

FIG. 15 thus illustrates an example of a suitable computing system environment 1500a in which some aspects of the disclosed subject matter can be implemented, although as made clear above, the computing system environment 1500a is only one example of a suitable computing environment for a device and is not intended to suggest any limitation as to the scope of use or functionality of the disclosed subject matter. Neither should the computing environment 1500a be interpreted as having any dependency or requirement relating to any one or combination of components illustrated in the exemplary operating environment 1500a.

With reference to FIG. 15, an exemplary device for implementing the disclosed subject matter includes a general-purpose computing device in the form of a computer 1510a. Components of computer 1510a may include, but are not limited to, a processing unit 1520a, a system memory 1530a, and a system bus 1521a that couples various system components including the system memory to the processing unit 1520a. The system bus 1521a may be any of several types of bus structures including a memory bus or memory controller, a peripheral bus, and a local bus using any of a variety of bus architectures.

Computer 1510a typically includes a variety of computer readable media. Computer readable media can be any available media that can be accessed by computer 1510a. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510a. Communication media typically embodies computer readable instructions, data structures, program modules, or other data in a modulated data signal such as a carrier wave or other transport mechanism and includes any information delivery media.

The system memory 1530a may include computer storage media in the form of volatile and/or nonvolatile memory such as read only memory (ROM) and/or random access memory (RAM). A basic input/output system (BIOS), containing the basic routines that help to transfer information between elements within computer 1510a, such as during start-up, may be stored in memory 1530a. Memory 1530a typically also contains data and/or program modules that are immediately accessible to and/or presently being operated on by processing unit 1520a. By way of example, and not limitation, memory 1530a may also include an operating system, application programs, other program modules, and program data.

The computer 1510a may also include other removable/non-removable, volatile/nonvolatile computer storage media. For example, computer 1510a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 1521a through a non-removable memory interface such as an interface, and a magnetic disk drive or optical disk drive is typically connected to the system bus 1521a by a removable memory interface, such as an interface.

A user can enter commands and information into the computer 1510a through input devices such as a keyboard and pointing device, commonly referred to as a mouse, trackball, or touch pad. Other input devices can include a microphone, joystick, game pad, satellite dish, scanner, wireless device keypad, voice commands, or the like. These and other input devices are often connected to the processing unit 1520a through user input 1540a and associated interface(s) that are coupled to the system bus 1521a, but may be connected by other interface and bus structures, such as a parallel port, game port, or a universal serial bus (USB). A graphics subsystem can also be connected to the system bus 1521a. A monitor or other type of display device can also be connected to the system bus 1521a via an interface, such as output interface 1550a, which may in turn communicate with video memory. In addition to a monitor, computers can also include other peripheral output devices such as speakers and a printer, which can be connected through output interface 1550a.

The computer 1510a can operate in a networked or distributed environment using logical connections to one or more other remote computer(s), such as remote computer 1570a, which can in turn have media capabilities different from device 1510a. The remote computer 1570a can be a personal computer, a server, a router, a network PC, a peer device, personal digital assistant (PDA), cell phone, handheld computing device, or other common network node, or any other remote media consumption or transmission device, and may include any or all of the elements described above relative to the computer 1510a. The logical connections depicted in FIG. 15 include a network 1571a, such local area network (LAN) or a wide area network (WAN), but can also include other networks/buses, either wired or wireless. Such networking environments are commonplace in homes, offices, enterprise-wide computer networks, intranets and the Internet.

When used in a LAN networking environment, the computer 1510a can be connected to the LAN 1571a through a network interface or adapter. When used in a WAN networking environment, the computer 1510a can typically include a communications component, such as a modem, or other means for establishing communications over the WAN, such as the Internet. A communications component, such as a modem and so on, which can be internal or external, can be connected to the system bus 1521a via the user input interface of input 1540a, or other appropriate mechanism. In a networked environment, program modules depicted relative to the computer 1510a, or portions thereof, can be stored in a remote memory storage device. It will be appreciated that the network connections shown and described are exemplary and other means of establishing a communications link between the computers can be used.

While the disclosed subject matter has been described in connection with the preferred embodiments of the various figures, it is to be understood that other similar embodiments may be used or modifications and additions may be made to the described embodiment for performing the same function of the disclosed subject matter without deviating therefrom. For example, one skilled in the art will recognize that the disclosed subject matter as described in the present application applies to communication systems using the disclosed techniques, systems, and methods and may be applied to any number of devices connected via a communications network and interacting across the network, either wired, wirelessly, or a combination thereof.

Accordingly, while words such as transmitted and received are used in reference to the described communications processes, it should be understood that such transmitting and receiving is not limited to digital communications systems, but could encompass any manner of sending and receiving data suitable for implementation of the described techniques. As a result, the disclosed subject matter should not be limited to any single embodiment, but rather should be construed in breadth and scope in accordance with the appended claims.

### Exemplary Communications Networks and Environments

The above-described communication systems using the techniques, systems, and methods may be applied to any network, however, the following description sets forth some exemplary telephony radio networks and non-limiting operating environments for communications made incident to the communication systems using the techniques, systems, and methods of the disclosed subject matter. The below-described operating environments should be considered non-exhaustive, however, and thus, the below-described network architecture merely shows one network architecture into which the disclosed subject matter may be incorporated. One can appreciate, however, that the disclosed subject matter may be incorporated into any now existing or future alternative architecture for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques, systems, and methods of the disclosed subject matter can be applied independently of the method of data transport, and does not depend on any particular network architecture, or underlying protocols.

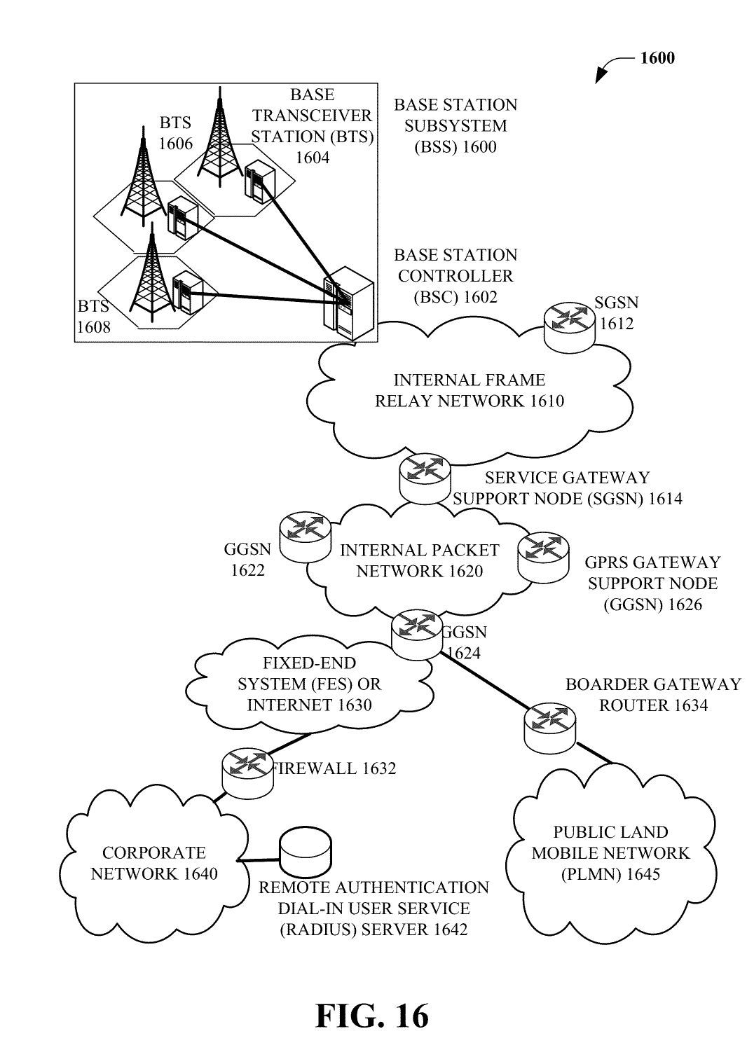

FIG. 16 depicts an overall block diagram of an exemplary packet-based mobile cellular network environment, such as a GPRS network, in which the disclosed subject matter may be practiced. In such an environment, there are one or more Base Station Subsystem(s) (“BSS”) 1600 (only one is shown), each of which comprises a Base Station Controller (“BSC”) 1602 serving a plurality of Base Transceiver Stations (“BTS”) such as BTSs 1604, 1606, and 1608. BTSs 1604, 1606, 1608, etc. are the access points where users of packet-based mobile devices become connected to the wireless network. In exemplary fashion, the packet traffic originating from user devices is transported over the air interface to a BTS 1608, and from the BTS 1608 to the BSC 1602. Base station subsystems, such as BSS 1600, are a part of internal frame relay network 1610 that can include Service GPRS Support Nodes (“SGSN”) such as SGSN 1612 and 1614. Each SGSN is in turn connected to an internal packet network 1620 through which a SGSN 1612, 1614, etc. can route data packets to and from a plurality of gateway GPRS support nodes (GGSN) 1622, 1624, 1626, etc. As illustrated, SGSN 1614 and GGSNs 1622, 1624, and 1626 are part of internal packet network 1620. Gateway GPRS serving nodes 1622, 1624 and 1626 mainly provide an interface to external Internet Protocol (“IP”) networks such as Public Land Mobile Network (“PLMN”) 1645, corporate intranets 1640, or Fixed-End System (“FES”) or the public Internet 1630. As illustrated, subscriber corporate network 1640 may be connected to GGSN 1624 via firewall 1632; and PLMN 1645 is connected to GGSN 1624 via boarder gateway router 1634. The Remote Authentication Dial-In User Service (“RADIUS”) server 1642 can be used for caller authentication when a user of a mobile cellular device calls corporate network 1640.

Generally, there can be four different cell sizes in a GSM network-macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the disclosed subject matter described herein can have aspects that are wholly in hardware, partly in hardware and partly in software, as well as in software. Furthermore, aspects may be fully integrated into a single component, be assembled from discrete devices, components, or sub-components, or implemented as a combination suitable to the particular application and is a matter of design choice. As used herein, the terms “device,” “component,” “system,” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more component(s) can reside within a process and/or thread of execution and a component can be localized on one computer and/or distributed between two or more computers.

Thus, the systems of the disclosed subject matter, or certain aspects or portions thereof, may take the form of program code (e.g., instructions) embodied in tangible computer readable media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device can generally include a processor, a storage medium readable by the processor (including volatile and non-volatile memory and/or storage elements), at least one input device, and at least one output device. In addition, the components can communicate via local and/or remote processes such as in accordance with a signal having one or more data packet(s) (e.g., data from one component interacting with another component in a local system, distributed system, and/or across a network such as the Internet with other systems via the signal).

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, some aspects of the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, it is known that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the various embodiments.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more component(s) can be combined into a single component providing aggregate functionality or divided into several separate sub-components, and any one or more middle layer(s), such as a management layer, may be provided to communicatively couple to such sub-components in order to provide integrated functionality. Any components described herein may also interact with one or more other component(s) not specifically described herein but generally known by those of skill in the art.

While for purposes of simplicity of explanation, methodologies disclosed herein are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated, various portions of the disclosed systems may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers, etc.). Such components, inter alia, can automate certain mechanisms or processes performed thereby to make portions of the systems and methods more adaptive as well as efficient and intelligent.

While the disclosed subject matter has been described in connection with the particular embodiments of the various figures, it is to be understood that other similar embodiments can be used or modifications and additions can be made to the described embodiment for performing the same function of the disclosed subject matter without deviating therefrom. Still further, the disclosed subject matter can be implemented in or across a plurality of processing chips or devices, and storage can similarly be effected across a plurality of devices. Therefore, the disclosed subject matter should not be limited to any single embodiment, but rather should be construed in breadth and scope in accordance with the appended claims.

What is claimed is:

1. A method for generating a user authentication credential comprising:
presenting a plurality of sets of images via a user interface of a computer;
receiving input that indicates a selection of a subset of images of the plurality of sets of images, wherein the selection corresponds to a grammatical structure; and
storing or transmitting at least one of the selection or the grammatical structure as the user authentication credential.

2. The method of claim 1, wherein the presenting the plurality of sets of images includes presenting at least one of the plurality of sets of images, one image per set at a time, based in part on a random or pseudo-random determination of images to be presented.

3. The method of claim 1, wherein the presenting the plurality of sets of images includes generating at least one of the plurality of sets of images from a second set of images based in part on random or pseudo-random selection of images to be presented in the at least one of the plurality of sets of images, wherein the at least one of the plurality of sets of images comprises a subset of images from the second set of images.

4. The method of claim 1, wherein the receiving the input includes receiving a combination of an image of the selection and a subset of the grammatical structure.

5. The method of claim 1, further comprising:
presenting a second plurality of sets of images based in part on at least one of a rejection of the plurality of sets of images, a requirement to reset the user authentication credential, or passage of a predetermined period of time;
receiving the input based on the second plurality of sets of images; and
storing or transmitting the user authentication credential based on the second plurality of sets of images.

6. The method of claim 1, wherein the presenting includes presenting the plurality of sets of images in a row of images to facilitate scrolling at least one image of the row of images to allow viewing alternate images in at least one of the plurality of sets of images.

7. The method of claim 1, wherein the presenting the plurality of sets of images includes presenting the plurality of sets of images, wherein at least one of the plurality of sets of images is associated with one of a number of disparate parts of speech.

8. The method of claim 7, wherein the presenting the plurality of sets of images includes presenting at least one of the plurality of sets of images based in part on determining which of the number of disparate parts of speech associated with the plurality of sets of images is presented.

9. The method of claim 7, wherein the presenting the plurality of sets of images includes presenting the plurality of sets of images, wherein at least one image of the plurality of sets of images comprises a plurality of sub-images, and wherein at least one of the sub-images is associated with one of the number of disparate parts of speech.

10. The method of claim 7, wherein the presenting includes presenting respective labels associated with the plurality of sets of images, wherein at least one of the respective labels is associated with a subset of the number of disparate parts of speech.

11. The method of claim 7, wherein the presenting the plurality of sets of images includes presenting at least one further set of images associated with an additional disparate part of speech comprising at least one of an adjective, a pronoun, a complement, a direct object, an indirect object, a preposition, or an object of the preposition.

12. The method of claim 11, wherein the receiving the input includes receiving input comprising the grammatical structure including at least one of the adjective, the pronoun, the complement, the direct object, the indirect object, the preposition, or the object of the preposition.

13. A computer readable storage medium comprising computer executable instructions that, in response to execution, cause a computing device to perform operations, comprising:
presenting a series of images via a user interface generated by the computing device;
receiving input comprising at least one of a selection of a subset of images of the series of images or a grammatical structure, wherein the selection is associated with a user authentication credential; and
verifying the input matches a stored user authentication credential.

14. The computer readable storage medium of claim 13, wherein the receiving input includes receiving a combination of an image of the selection and a subset of the grammatical structure.

15. The computer readable storage medium of claim 13, wherein the presenting includes presenting the series of images in a row of images to facilitate manual scrolling of at least one image of the row of images to allow viewing alternate images in at least one of the series of images.

16. The computer readable storage medium of claim 13, wherein the presenting the series of images includes presenting the series of images, wherein at least one of the series of images is associated with one of a plurality of disparate parts of speech.

17. The computer readable storage medium of claim 13, wherein the presenting the series of images includes presenting the series of images, wherein at least one image of the series of images comprises a plurality of sub-images, and wherein at least one of the sub-images is associated with one of the plurality of disparate parts of speech.

18. The computer readable storage medium of claim 13, wherein the presenting includes presenting respective labels associated with the series of images, wherein at least one of the respective labels is associated with a subset of the plurality of disparate parts of speech.

19. The computer readable storage medium of claim 13, wherein the presenting the series of images includes presenting at least one additional image associated with an additional disparate part of speech comprising at least one of an adjective, a pronoun, a complement, a direct object, an indirect object, a preposition, or an object of the preposition.

20. The computer readable storage medium of claim 13, wherein the receiving input comprised of the grammatical structure includes receiving at least one of the adjective, the pronoun, the complement, the direct object, the indirect object, the preposition, or the object of the preposition.

21. The computer readable storage medium of claim 13, the operations further comprising:
at least one of determining that the input does not match the stored user authentication credential or denying user access based in part on the determining that the input that does not match the stored user authentication credential a predetermined number times.

22. The computer readable storage medium of claim 21, the operations further comprising:
presenting a second series of images in response to at least one of the determining, a requirement to reset the user authentication credential, or passage of a predetermined period of time;
receiving the input based on the second series of images; and
at least one of verifying the input matches the stored user authentication credential, storing the input as the user authentication credential, or transmitting the input as the user authentication credential.

23. A user authentication system, comprising:
a user interface component configured to display a series of images;
an input component configured to accept input comprising at least one of a selection of a subset of images of the series of images or a grammatical structure, wherein the selection is associated with a user authentication credential; and
an authentication component configured to verify the input matches a stored user authentication credential.

24. The system of claim 23, wherein the input component is further configured to accept a combination of an image of the selection and a subset of the grammatical structure.

25. The system of claim 23, wherein the user interface component is further configured to display the series of images in a row of images to facilitate manual scrolling of at least one image of the row of images and to allow display of alternate images in at least one of the series of images.

26. The system of claim 23, wherein the authentication component is further configured to compare the input to a stored user authentication credential and at least one of determine that the input does not match the stored user authentication credential or determine that the input does not match the stored user authentication credential not match based on a predetermined number of attempts.

27. The system of claim 23, wherein the user interface component is further configured to display the series of images, wherein at least one of the series of images is associated with one of a number of disparate parts of speech.

28. The system of claim 27, wherein the user interface component is further configured to display the series of images, wherein at least one image of the series of images comprises a plurality of sub-images, and wherein at least one of the sub-images is associated with one of the number of disparate parts of speech.

29. The system of claim 27, wherein the user interface component is further configured to display respective labels associated with the series of images, wherein at least one of the respective labels is associated with a subset of the number of disparate parts of speech.

30. A device, comprising
means for displaying a plurality of sets of images via a user interface of the device;
means for accepting input that indicates a selection of a subset of images of the plurality of sets of images, wherein the selection corresponds to a grammatical structure; and
means for storing or transmitting at least one of the selection or the grammatical structure as the user authentication credential.

31. The device of claim 30, wherein the means for accepting includes means for accepting a combination of an image of the selection and a subset of the grammatical structure.

32. The device of claim 30, wherein the means for displaying includes means for displaying the plurality of sets of images, wherein at least one of the plurality of sets of images is associated with one of a plurality of disparate parts of speech.

33. The device of claim 32, wherein the means for displaying includes means for displaying at least one of the plurality of sets of images based in part on a determination of which of the plurality of disparate parts of speech associated with the plurality of sets of images is displayed.

34. The device of claim 32, wherein the means for displaying includes means for displaying the plurality of sets of images, wherein at least one image of the plurality of sets of images comprises a plurality of sub-images, and wherein at least one of the sub-images is associated with one of the plurality of disparate parts of speech.

35. The device of claim 32, wherein the means for displaying includes means for displaying respective labels associated with the plurality of sets of images, wherein at least one of the respective labels is associated with a subset of the plurality of disparate parts of speech.
